(19) United States
(12) Patent Application Publication
(10) Pub. No.: US 2010/0100233 A1
(43) Pub. Date: Apr. 22, 2010

(54) UNIVERSAL INTELLIGENT POSTAL IDENTIFICATION CODE

(75) Inventor: Binh T. Lu, Endicott, NY (US)

Correspondence Address: MILES & STOCKBRIDGE PC, 1751 PINNACLE DRIVE , SUITE 500, MCLEAN, VA, 22102, US

(73) Assignee: LOCKHEED MARTIN CORPORATION, Bethesda, MD (US)

(21) Appl. No.: 12/604,033

(22) Filed: Oct. 22, 2009

Related U.S. Application Data
(60) Provisional application No. 61/107,612, filed on Oct. 22, 2008.

(51) Int. Cl. B07C 3/00; G06F 7/00; G06K 9/00; G07C 13/00

(52) U.S. Cl. 700/226; 382/102; 705/12

(57) ABSTRACT

A universal postal code system in which mail piece delivery address information is associated with a universal postal code affixed to a mail piece. As part of the association process, the delivery address information can be verified and formatted according to postal authority standards to help ensure reliable and efficient delivery. The universal postal codes are reusable after completion of delivery by reassigning a universal postal code to a new recipient. The universal postal codes permit mailing of a mail piece without having any human readable delivery or return address information visible on the mail piece. Universal postal codes can be used for military mail systems and systems requiring anonymous mailing. Universal postal codes can also be used for automatic tabulation of votes while maintaining voter anonymity. Universal postal codes can be used for mail delivery between different countries such that a sender in one country need not be familiar with the address conventions of another country, and can electronically associate a universal postal code with a recipient in the other country without a need for the sender to write or even recognize the recipient's address as written in a language used in the other country.

This application claims the benefit of U.S. Provisional Application No. 61/107,612, entitled “Universal Intelligent Postal Identification Code”, filed Oct. 22, 2009, which is incorporated herein by reference in its entirety.

Embodiments relate generally to mail sorting and delivery and, in particular, to mail addressing, sorting and delivery using a universal postal identification code.

One embodiment includes a computer readable medium having software instructions stored thereon for registering a universal postal code affixed to a mail piece, the software instructions, when executed by a processor (e.g., in a wireless device or handheld computer), cause the processor to perform operations. The operations include acquiring universal postal code data associated with a unique universal postal code, and verifying the universal postal code by communicating with a universal postal code server computer. The operations also include obtaining a recipient address to which the mail piece will be sent, and determining if the recipient address is valid. The operations further include associating the universal postal code with the recipient address, and transmitting the universal postal code data and the recipient address to the universal postal code server computer for registration in an active universal postal code database.

Another embodiment includes a universal postal code server computer including a processor, and a memory having stored therein software instructions for programming the processor to perform operations. The operations including receiving a universal postal code registration message from a mailer device, the universal postal code registration message including universal postal code data and recipient address information, and determining, based on the universal postal code data, whether a new universal postal code needs to be released or whether a previously released universal postal code is being used. The operations also include releasing a universal postal code when the determining indicates that a new universal postal code needs to be released, and verifying a previously released universal postal code when the determining indicates that a previously released universal postal code is being used. The operations further include verifying the recipient address information including conforming the address information to a standard address format when the recipient address information is not in the standard format, and adding the universal postal code and the recipient address information to an active universal postal code database.

Another embodiment includes a mail processing machine including a mail piece scanner, a processor coupled to the mail piece scanner, and a memory coupled to the processor, the memory having stored therein software instructions for programming the processor, the instructions, when executed by the processor cause the processor to perform operations. The operations include acquiring an image of a mail piece using the mail piece scanner, and automatically recognizing and decoding a universal postal code in the mail piece image to obtain a universal postal code associated with the mail piece. the operations further include requesting delivery address information from a universal postal code server by sending an electronic message containing the universal postal code associated with the mail piece, and receiving delivery address information from the universal postal code server. The operations also include sorting the mail piece for delivery according to the received delivery address information such that the mail piece can be delivered to the delivery address without performing an optical character recognition operation on the mail piece image to obtain the delivery address information.

In another embodiment, a mail piece addressing and delivery system includes a mail piece having a first universal postal code as a destination universal postal code and a second universal postal code as a sender universal postal code associated with an address of the sender, the mail piece having no human readable address information for either of a sender or a recipient. The system also includes a mail processing system adapted to automatically recognize and decode each of the first and second universal postal codes and deliver the mail piece according to a destination address associated with the destination universal postal code if possible. If delivery of the mail piece is not possible or is refused, the mail processing system being adapted to return the mail piece to the address of the sender.

Yet another embodiment includes a mail carrier device having a processor, a scanner coupled to the processor, the scanner adapted to scan universal postal codes, a display device coupled to the processor, and a memory coupled to the processor, the memory having software instructions stored therein for programming the processor to perform operations when the software instructions are executed. The operations include acquiring, using the scanner, an image of a universal postal code on a mail piece being delivered, and decoding the universal postal code image to obtain a universal postal code. The operations also include sending a message requesting delivery information for the mail piece, the message including the universal postal code, and displaying the delivery information on the display device. The operations further include sending a message indicating delivery of the mail piece.

Another embodiment includes a method for automatically tabulating votes. The method includes providing a block of universal postal codes to an election organization, the block of universal postal codes being associated with a mailing account of the election organization, and associating an address of the election organization with each of the universal postal codes in the block. The method also includes associating each universal postal code with a unique registered voter, and mailing ballot cards and one or more universal postal codes on adhesive labels to each voter, the ballot cards having neither a delivery address or postage affixed to them, wherein a voter can vote by affixing one or more universal postal code labels to a ballot card and placing the ballot card in the mail for delivery, the ballot card maintaining voter anonymity by having no human readable voter or ballot choices visible on the ballot card. The method further includes receiving the ballot card at a mail processing center and automatically recognizing and decoding the one or more universal postal codes on the ballot card, and securely transmitting electronically the decoded universal postal codes to the election organization such that votes can be tabulated automatically prior to the election organization physically receiving the ballot card. The method also includes delivering the ballot card in accordance with the delivery address information associated with the one or more universal postal codes.

### BRIEF DESCRIPTION OF THE DRAWINGS

FIG. 1 is a diagram of an exemplary universal intelligent postal identification code (UIPIC) system in accordance with the disclosure;

FIG. 2 is a diagram of an exemplary UIPIC system at a mail processing facility;

FIG. 3 is a diagram of an exemplary UIPIC system for mail delivery by a mail carrier;

FIG. 4 is a high-level diagram of a typical functional processing flow for a conventional, non-UIPIC mail in the United States Postal Service (USPS);

FIG. 6 is a block diagram of an exemplary functional processing flow of UIPIC enabled mail piece processing;

FIG. 7 is a flowchart for an exemplary method for sending a mail piece using a pre-existing UIPIC code;

FIG. 8 is a flowchart for an exemplary method for sending a mail piece when a new UIPIC code needs to be obtained;

FIG. 9 is a diagram of an exemplary lifecycle for a UIPIC code;

FIG. 10 is an exemplary UIPIC-enabled mail piece;

FIG. 11 is a diagram of a UIPIC-enabled mail piece that includes an address presentation portion;

FIGS. 12 and 13 show examples of a UIPIC application user interface;

FIG. 14 is a flowchart of an exemplary method of UIPIC server operation when receiving a request from a user device for registering a UIPIC-enabled mail piece;

FIG. 15 is a flowchart of an exemplary method of operating a UIPIC mail processing system;

FIG. 16 is a flowchart of an exemplary UIPIC server method of operation during UIPIC mail sorting;

FIG. 17 is a flowchart of an exemplary UIPIC mail delivery sequence for a mail carrier device;

FIG. 18 is a diagram of an exemplary user interface for a mail carrier device or application program;

FIG. 19 shows a postal carrier container for delivery of mail that does not include a recipient name and/or address printed on the mail piece;

FIG. 20 shows another exemplary embodiment of a delivery container having single delivery point sub-containers;

FIG. 21 is a diagram of an exemplary container having a radio frequency identification (RFID) sensing device or antenna;

FIG. 22 is a flowchart of an exemplary embodiment of a method for processing delivery information at a UIPIC server;

FIG. 23 is a flowchart of an exemplary method of receiving and updating the user device with delivery confirmation information;

FIG. 24 is a flowchart of an exemplary embodiment of a method for using UIPIC-enabled mail pieces for sending to members of the armed forces or military;

FIG. 25 is a flowchart of an exemplary method for sending UIPIC-enabled mail to a user of a social networking website;

FIG. 26 is a flowchart of an exemplary method for using UIPIC-enabled mail with ecommerce or other electronic automated method;

FIG. 27 is a flowchart of an exemplary method for making a mail-order purchase using a UIPIC-enabled return mail piece;

FIG. 28 is a flowchart of a method of voting by mail using UIPIC enabled mail pieces and voting labels;

FIG. 29 is a flowchart showing an exemplary method for sending UIPIC-enabled mail when the user device is not able to access a network;

FIG. 30 is a flowchart of an exemplary method for estimating parcel dimensions and weight using a UIPIC-enabled handheld device;

FIG. 31 is a flowchart showing an exemplary embodiment of a method for providing forensic (or audit) mailing information from a UIPIC system;

FIG. 32 is a flowchart showing an exemplary method for “one-click” mailing using a UIPIC system;

FIG. 33 is flowchart of an exemplary method for redirecting or forwarding mail without requesting forwarding service from the post office;

FIG. 34 is a flowchart showing an exemplary method of generating revenue from advertisements displayed on a UIPIC application program executing on a user device;

FIG. 35 is a flowchart of an exemplary method for downloading and installing a UIPIC application program in a user device;

FIG. 36 is a block diagram of an exemplary UIPIC database hierarchy; and

FIG. 37 is flowchart showing an exemplary method for one-way or two-way anonymous mailing.

### DETAILED DESCRIPTION

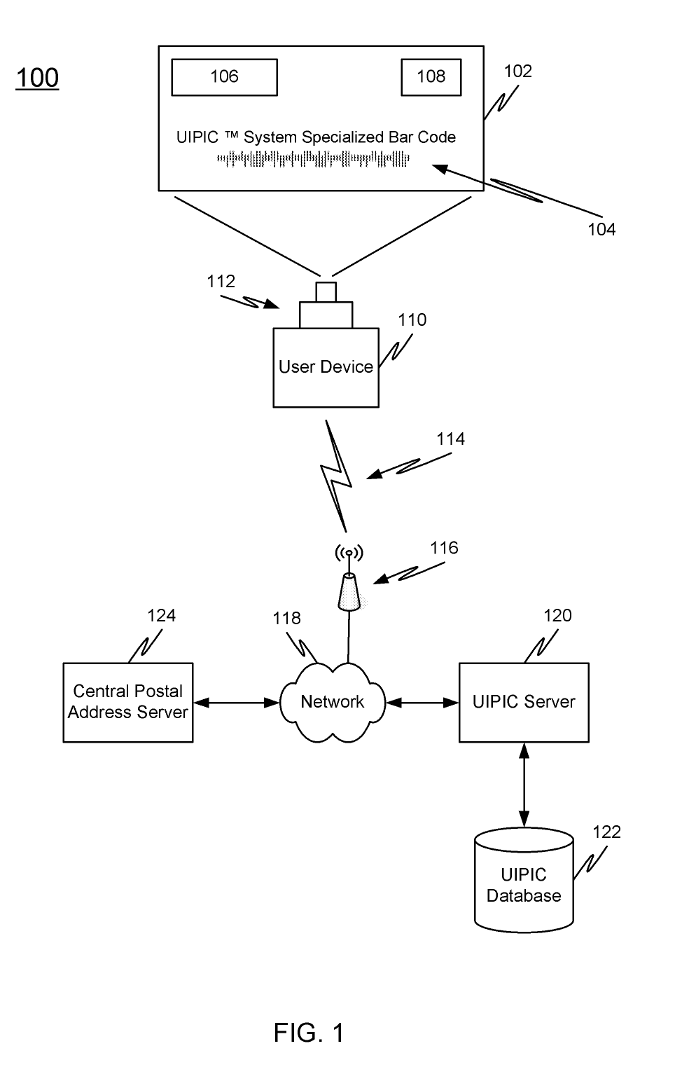

FIG. 1 is a diagram of an exemplary universal intelligent postal identification code (UIPIC) system. In particular, system 100 includes a mail piece 102 to which a UIPIC code symbol 104, an optional return address 106, and an optional postage indicium 108 have been applied. The system also includes a user device 110 that includes a digital camera 112. The system also includes a wireless link 114, a wireless access point 116, and a network 118. Connected to the network are a UIPIC server 120, a UIPIC database 122, and a central postal address server (CPAS) 124.

In operation, a user obtains the mail piece (e.g., envelope) 102 having a UIPIC symbol 104 applied to the mail piece 102. The UIPIC symbol 104 can be pre-printed on the mail piece, can be supplied as an adhesive label, or may be printed by the user directly on the mail piece or on an adhesive label provided by the user.

In order to mail the mail piece 102, the user invokes (or runs) a UIPIC application program on the user device 110. Through the UIPIC application program, the user acquires an image of the mail piece 102 using the digital camera 112 of the user device 110. The mail piece image can then be automatically analyzed to recognize the UIPIC symbol 104. Once the UIPIC symbol has been recognized, it can then be read, decoded and verified.

The mail piece 102 does not necessarily need to include postage. The postage can be determined by the postal authority or delivery service and can be charged to the user's account that has been previously associated with the user. Thus, the postage indicium 108 may include actual postage or can include a notation that postage will be paid upon mailing. In addition, the mail piece can include a postage indicium 108 that includes a certain amount of postage and a balance due or credit for over payment can be charged or credited to the user's account upon mailing. The relationship to an account used for charging purposes can be based on the user (e.g., though a login identification or the like), the device (a unique identification code associated with the device such as a serial number or telephone number), or through the application program serial number or registration number. Also, there may be an account information file present on the device that can enable the UIPIC application program to determine the appropriate account to charge or credit during delivery of the mail piece 102. This type of information file could be encrypted or in plain text and may be distributed, for example, to employees of an organization so that they can mail items and the charges will accrue to the organization and not the individual. The UIPIC application program can also have a facility for alternate billing account information to be entered so that, for example, a personal mailing can be made from a company device or another person's device for mailing with the charges accruing to mailer and not the owner of the device.

The user device 110, through the UIPIC application program, communicates the UIPIC code information to the UIPIC server 120. The user device 110 communicates with the UIPIC server 120 via a wireless link 114 to the wireless access point 116 that is coupled to the network 118. The UIPIC server 120 is also coupled to the network 118. Thus, the user device 110 can establish a communication link with the UIPIC server 120 in order to verify the UIPIC code. Verification can include determining if the UIPIC code is unique and is not otherwise in use. Verification can also include determining if the UIPIC is not flagged as being invalid or unusable for other reasons, such as suspected fraudulent activity, insufficient account funds, etc.

Once the UIPIC code 104 has been verified, a verification acknowledgement is sent from the UIPIC server 120 to the user device 110. If the UIPIC code is valid, then the UIPIC application program continues and acquires a destination address for the mail piece 102 from the user. The address can be manually entered by the user or the address can be acquired from an address book or other electronic address forms present in the user device 110. If the address is acquired electronically from the user device, the user could be presented with a list of addresses (e.g., those addresses present in the user's contact list in the user device 110) and the user could simply select an address from among the list presented.

Once the destination address has been acquired, it is verified. To verify the address, the UIPIC application program sends the destination address information from the UIPIC application to the UIPIC server 120. The UIPIC server 120 then sends the destination address data to the CPAS 124. The CPAS 124 represents the database of a central postal authority (e.g., the United States Postal Service). The CPAS can include an interface for receiving address data from the UIPIC server 120 and returning an indication of the validity of the address along with any other pertinent information, such as a forwarding address if one is being used, or a standard form of the address being verified. If the mail recipient has requested forwarding for the destination address, the user device application program can receive a forwarding address from the UIPIC server 120 and prompt the user as to whether the user would like to update the user device address book or contact list to reflect the forwarding address.

Also, if the destination address provided by the UIPIC server 120 is ambiguous, the CPAS 124 could return a list of addresses that may correspond to the one received from the UIPIC server 120. The UIPIC server can, in turn, provide the list to the user device so that the user can select the intended destination address.

At this point, the UIPIC application program has acquired and verified the UIPIC code 104 and the destination address of the mail piece 102. It should be noted that the destination address has not been applied to the mail piece.

The UIPIC application program then makes an inquiry to the user, via a user interface of the UIPIC application program displayed on the user device 110, as to the type of delivery service being requested and whether the user would like any additional services to be added.

Once the delivery service type and options have been confirmed with the user, the UIPIC application program registers the UIPIC code, the destination address, and any optional services with the UIPIC server 120. The UIPIC server 120 creates a database record in the UIPIC database 122 that includes the UIPIC code, the destination address and any optional services requested by the user. The address verification process can also include the return of a delivery point code (or other type of delivery code) that can be the finest depth of sort (or other depth of sort) code available from the CPAS 124 to the UIPIC server 120. The UIPIC database record can also include other information such as an identification number of the user device, a registration/serial number of the UIPIC application program, a user account number, a date/time stamp, or the like.

The user can now deposit the mail piece 102 with the postal authority for delivery to the destination address. The verified destination address has been associated with the UIPIC code and stored in the UIPIC database 122 and is available for retrieval during a subsequent sorting or delivery operation by reference to only the UIPIC code. In other words, a verified destination address is now associated with the mail piece 102 and is retrievable during a mail sorting operation using only the UIPIC information as read from the UIPIC code 104 applied to the envelope. This eliminates the need for machine recognition of a handwritten or printed address on a mail piece. Also, the address has been verified against the CPAS database 124, which further eliminates or reduces errors in the destination address. Because bar code reading can be significantly more accurate, cost-effective, and reliable as compared to handwritten or machine printed address recognition, a more efficient and predictable mail delivery service is possible. Also, because mail pieces can be associated with a destination address verified by the sender and a postal authority prior to placing them into the mail stream for delivery, the UIPIC system may make it possible for a postal authority or mail delivery service to deliver a higher percentage of mail to the correct destination address as compared to a traditional automatic address recognition system augmented with human video coders.

The user device can be a portable electronic device such as one (or a combination of more than one) of the following: a web-enabled device coupled to or containing a camera; a wireless telephone handset (e.g., Apple iPhone®); a personal digital assistant (PDA) such as a Blackberry®, Palm® computing device or the like; a handheld computer; a laptop computer (or other type of portable computer such as a tablet computer or portable bar code reader device used by delivery/shipping personnel); a smart phone; a media recorder such as a digital camera or digital video recorder; a digital media player such as an iPod, an mp3 player, or a electronic book reader; a handheld game console; a personal navigation device; a converged device, or the like. The user device can also be a desktop computer such as an IBM-compatible personal computer (PC) or an Apple Mac®. In general, any now known or later developed device or combination of devices that can carry out the functions described above in connection with the user device 110 in the same or a similar way can be used with an embodiment of the present invention.

The output of the UIPIC application program can be through a graphical user interface (GUI) that is displayed on a screen, optionally, the output can be through an audio interface or other non-visual interface. In general, any now known or later developed user interface or output device that is capable of providing information from the UIPIC application program to the user can be used with an embodiment of the present invention.

User input can be received at the user device 110 via a touch-screen, keyboard, pointing device (mouse, trackball or the like), gesture-based input device, audio input device, or the like. In general, any now known or later developed input device or interface that is capable of receiving input from a user that is suitable for the types of functions described above can be used with an embodiment of the present invention.

The connection from the user device 110 to the network 118 is shown in FIG. 1 as wireless, however, it should be appreciated that the connection could also be a wired connection. In general, any now known or later developed means for communicating data can be used for the connection between any of the components shown, such as radio frequency, optical, wired connection, or the like.

Also, one CPAS (124) is shown for simplicity. However, it will be appreciated that the UIPIC server 120 could connect to as many CPAS databases as needed or desired for a particular implementation of the system. In general, a government, or political subdivision of a government, public postal authorities, private delivery services, or the like, may all cooperate in a UIPIC network and agree to participate in the UIPIC functions such as UIPIC code verification, destination address verification, and any of the other functions of an embodiment of a UIPIC system described herein where data sharing, verification, communication, or cooperation among entities is appropriate. Here, CPAS is being used as an example of a source of address verification. Other sources may be used. The other sources may be public or private and may be intended to serve as address verification or may be intended for another purpose, but which are being used by the UIPIC system for address verification/confidence purposes. For example, the UIPIC system could send an inquiry to an online phonebook or other listing to seek confirmation of an address.

The digital camera 112 may be integrated with the user device, for example in common wireless phones or personal digital assistants (PDAs) that include a camera built-in to the device. The digital camera 112 can also be a separate device coupled to the user device, such as a stand-alone digital camera, a scanner, or other suitable digital imaging device. In general, any now known or later-developed imaging device that can acquire an image suitable for use in the manner described above can be used with an embodiment of the present invention.

The UIPIC database can be a relational database or any other now known or later developed database system that is suitable for performing the functions described above. The wireless link 114 can be a WiFi, broadband wireless, or any other now known or later developed wireless protocol that is suitable for performing the functions described above. The wireless access point 116 is operable to communicate with the user device 110 through the wireless link 114 in a compatible protocol. The network 118 can be a network such as the Internet, a local area network (LAN), a wide area network (WAN), a virtual private network (VPN), a direct connection network (or point-to-point), or the like. In general, the network can include one or more now known or later developed technologies for communicating information that would be suitable for performing the functions described above. The selection of network components and technologies can depend on a contemplated embodiment.

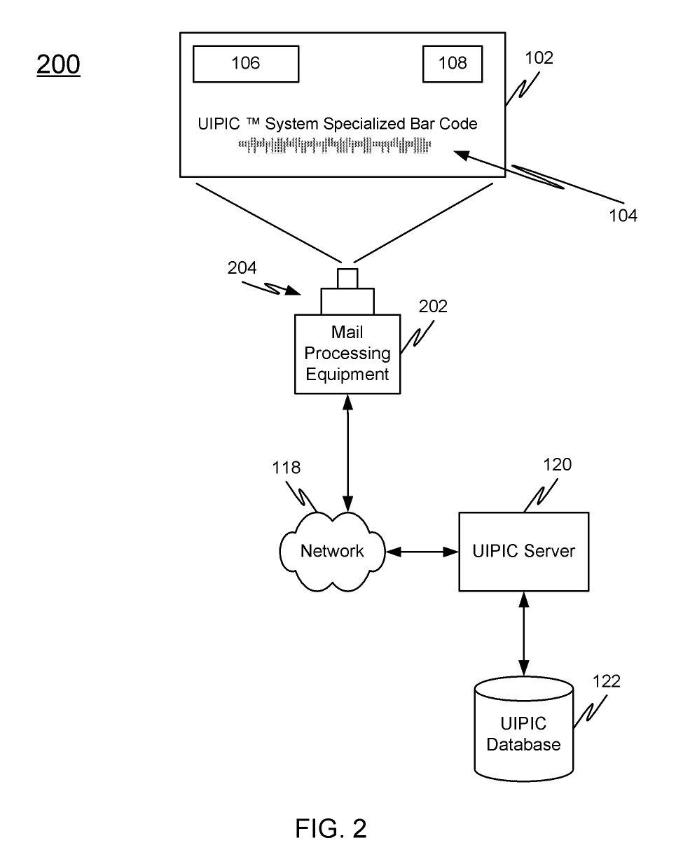

FIG. 2 is a diagram of an exemplary UIPIC system at a mail processing facility. In particular, the system 200 includes mail processing equipment 202 that includes an imaging device 204, in addition to those items described above in connection with FIG. 1.

In operation, the mail processing equipment 202 acquires an image of the mail piece 102 via the imaging device 204. Based on the acquired image, the mail processing equipment 202 identifies and reads the UIPIC code 104. The UIPIC code information is then transmitted to the UIPIC server 120 via the network 118.

The UIPIC server 120 then retrieves the database record that corresponds to the UIPIC code. Once the database record is retrieved, sorting information such as the destination address or delivery point code can be returned to the MPE 202 and used to sort the mail piece 102.

In the event the UIPIC code is not present in the UIPIC database 122, the UIPIC server 120 can return a message to the MPE 202 indicating that the UIPIC code was not found in the UIPIC database. Because the mail piece may not have a destination address printed on it, then it may need to be returned to the return address. As an alternative, the UIPIC system may be able to determine a probable sender of the mail piece based on the sequence of UIPIC codes that have been processed previously. For example, if a certain group of UIPIC codes was purchased or obtained by a known customer, then the UIPIC system could attempt to contact the customer, for example via email, to determine the destination address for the mail piece.

The process of the MPE 202 reading the UIPIC code 104 on the mail piece 102 and sending the UIPIC code to the UIPIC server 120 to retrieve destination or delivery information can be repeated as necessary to accomplish a contemplated sorting process.

Also, during a multi-pass sorting operation, the MPE 202 can retrieve delivery information corresponding to the UIPIC code from the UIPIC server 120 and then store the delivery information in a local database so that it may be possible to retrieve the delivery information with less latency during a subsequent sorting pass. The delivery information can also be forwarded to another mail processing machine in the same or a different facility in advance of a subsequent sorting pass so that it may be possible to reduce latency associated with the UIPIC look up process for the other machine.

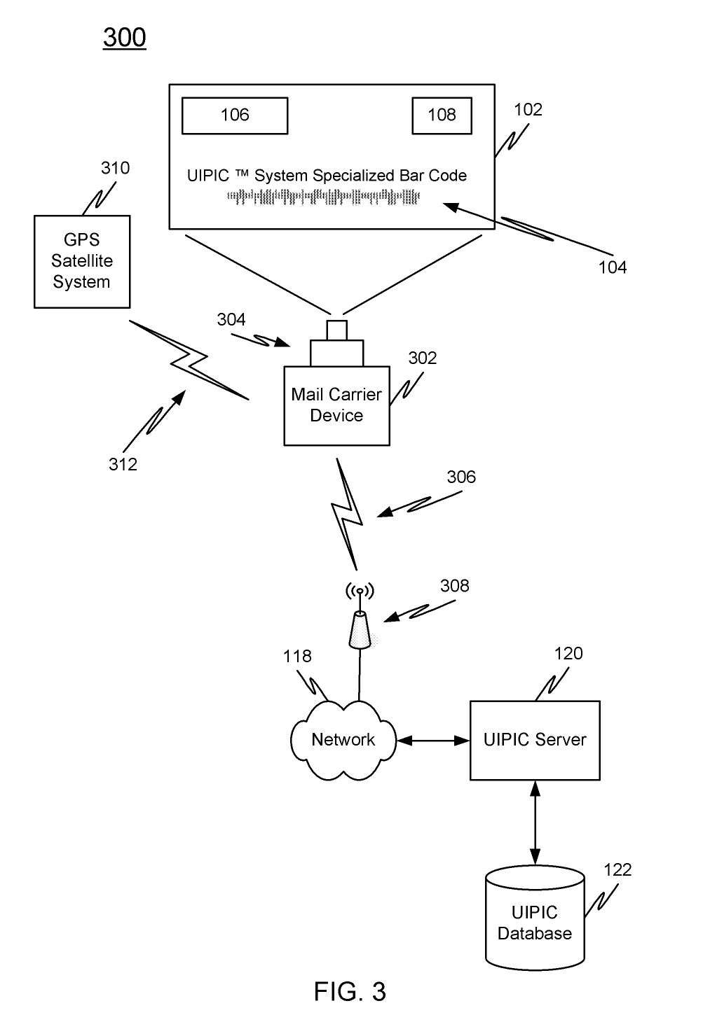

FIG. 3 is a diagram of an exemplary UIPIC system for mail delivery by a mail carrier. In particular, the system 300 includes a mail carrier device 302 that is equipped with a digital camera 304. The mail carrier device shown also includes a global positioning system (GPS) receiver to receive positioning information from the GPS satellite system 310 via wireless GPS signal 312. The mail carrier device 302 can also communicate with the network 118 via wireless link 306 and wireless access point 308.

In operation, a mail carrier can acquire an image of the mail piece 102 using a mail carrier application program executed on the mail carrier device 302. The mail carrier application can transmit the UIPIC code, and possibly other information, to the UIPIC server 120 via the network 118. The UIPIC server 120 can update the UIPIC database record associated with the UIPIC code to indicate that the mail piece has been delivered. In addition to the UIPIC code, the information sent to the UIPIC server 120 can include an identification of the mail carrier device 302, mail carrier identification, a date/time of delivery, delivery location information obtained via GPS, an image of a person receiving the mail piece or of a location where the mail piece is being deposited.

Once the UIPIC server 120 receives the delivery information from the mail carrier device 302, the delivery information can be used to provide additional services such as delivery confirmation.

The UIPIC server 120 can also release the UIPIC code for re-use once the mail piece 102 has been delivered. Alternatively, the UIPIC server can release the UIPIC code after a predetermined time period after delivery or after another predetermined period of time if the UIPIC code has not been used.

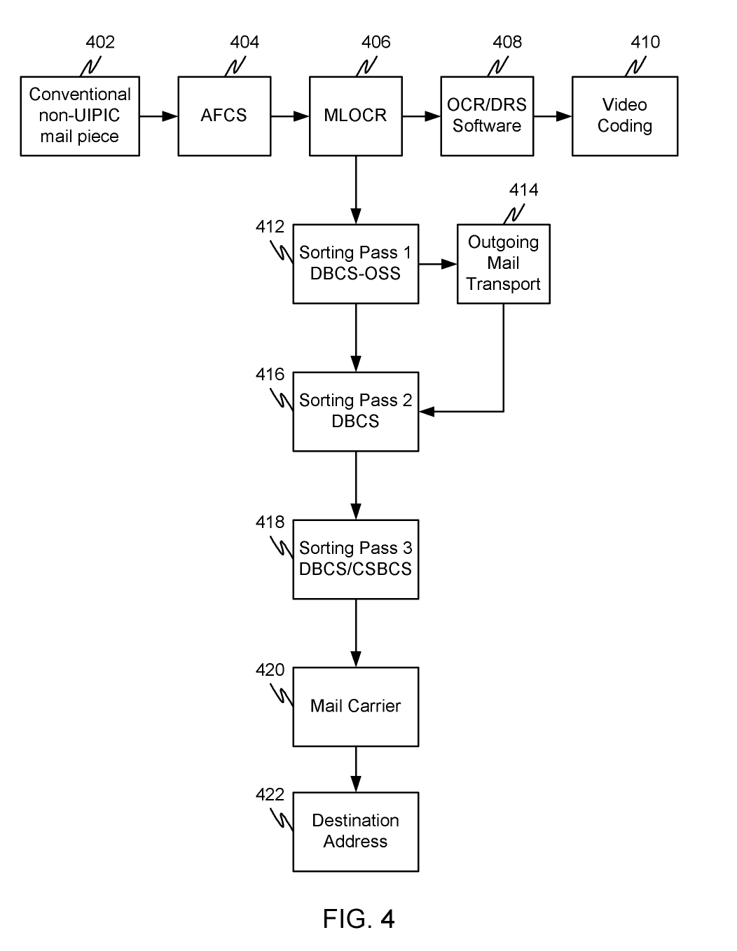

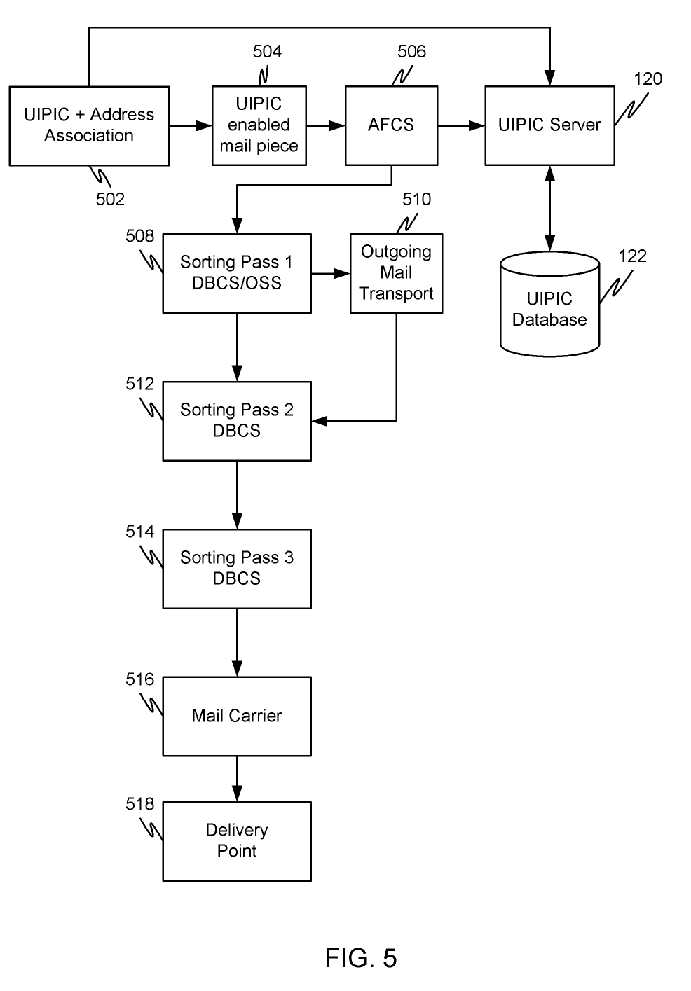

FIG. 4 shows a high-level diagram of a typical functional processing flow for a conventional, non-UIPIC mail in the United States Postal Service (USPS). A non-UIPIC enabled mail piece 402 is first presented to an automated facer/canceller system 404 that faces (orients the mail piece properly for reading) and cancels (mark a postage indicium as being used) a mail piece. In contrast, a UIPIC enabled mail piece does not necessarily have postage on it that requires canceling.

Once the mail piece 402 has been faced and cancelled, it can be passed in front of a multi-line optical character recognition system in order to acquire an image of the mail piece 402 for use in automatic recognition of address blocks (destination, return, or both). The image of the mail piece 402 can be sent to OCR software 408 for automatic address recognition. If automatic recognition is not possible to a desired level of certainty or fineness, the mail piece image can be sent to a video coding 410 for resolution by a human operator. In contrast to the conventional system, a UIPIC system can reduce or eliminate the need for the OCR software 408 and the video coding 410.

Once the destination address has been resolved, the destination information can be provided to a delivery bar code sorter (DBCS) for a first mail sorting pass (412). After the first sorting pass, the mail piece may need to be transported (414) if it is an outgoing mail piece destined for an addresses serviced by a mail processing center in another area. A second or third sorting pass (416, 418) on a DBCS machine may be performed such that the mail piece 402 can be provided to a mail carrier 420 for delivery to the destination address 422.

FIG. 5 is a block diagram of an exemplary functional processing flow of UIPIC enabled mail piece processing within the USPS. First, a user (postal customer) establishes an association between a UIPIC code on a mail piece and a destination address 502 and communicates the UIPIC code-destination address information to the UIPIC server 120. The user then places the mail piece 504 into the mail stream for delivery. At the first stage of mail processing, the AFCS 506, which has been configured to recognize UIPIC codes on mail pieces, recognizes the UIPIC code on the mail piece 504 and communicates with the UIPIC server to resolve a destination address based on the UIPIC code. Using the destination address information obtained form the UIPIC server 120, the DBCS can sort the mail piece according to the destination address at each stage: outgoing or local sort (508), 5-digit local sort (512), walk sequence (514) and may include transport 510. The mail piece can be provided to a mail carrier 516 for delivery to a destination address 518.

As can be seen from FIG. 5, UIPIC enabled mail processing does not require steps 406-410 shown in FIG. 4. By reducing or eliminating a need for steps 406-410, a UIPIC system can provide improved mail delivery rates and reduced mail sorting costs.

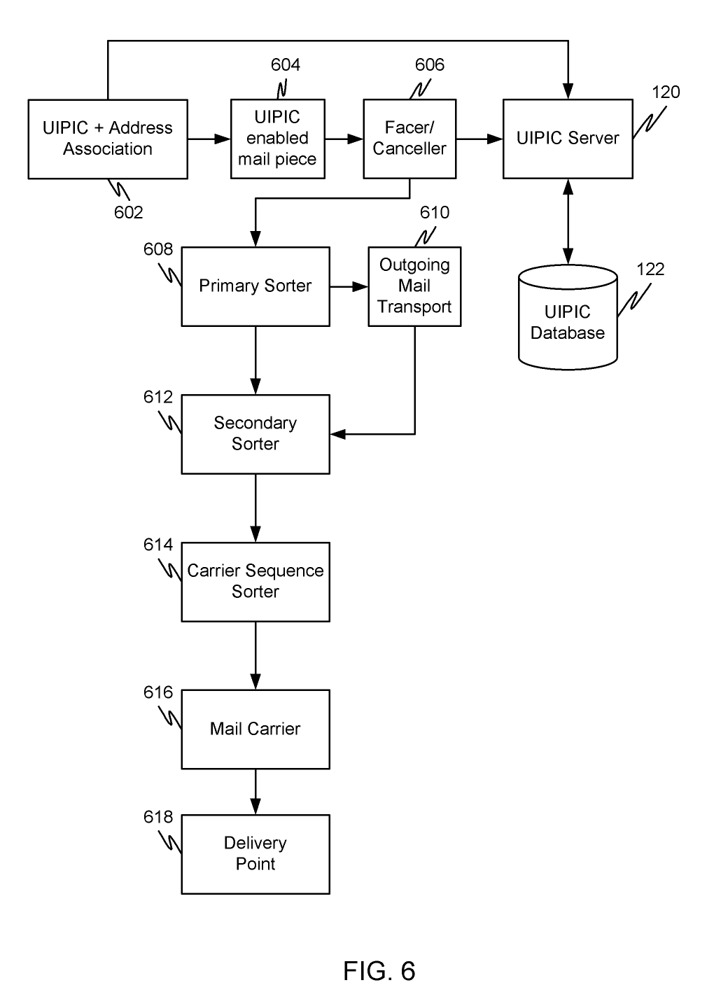

FIG. 6 is a block diagram of an exemplary functional processing flow of UIPIC enabled mail piece processing. First, a user (postal customer) establishes an association between a UIPIC code on a mail piece and a destination address 602 and communicates the UIPIC code-destination address information to the UIPIC server 120. The user then places the mail piece 604 into the mail stream for delivery. At the first stage of mail processing, a Facer/Canceller 606, which has been configured to recognize UIPIC codes on mail pieces, recognizes the UIPIC code on the mail piece 604 and communicates with the UIPIC server to resolve a destination address based on the UIPIC code. Using the destination address information obtained form the UIPIC server 120, the sorters can sort the mail piece according to the destination address at a series of stages: primary sorter 608 for outgoing or local sort, secondary sorter (612) for 5-digit local sort, carrier sequence sorter (614) for walk sequence sorting. The sorting may include transport 610. The mail piece can be provided to a mail carrier 616 for delivery to the destination address 618 that was associated or connected with the UIPIC code by the user at step 602.

The UIPIC system embodiment shown FIG. 6 does not require steps 406-410 shown in FIG. 4. By reducing or eliminating a need for steps 406-410, a UIPIC system embodiment can provide improved mail delivery rates by reducing ambiguity or misread addresses on mail pieces and reduced mail sorting costs by reducing the need for video coding operators.

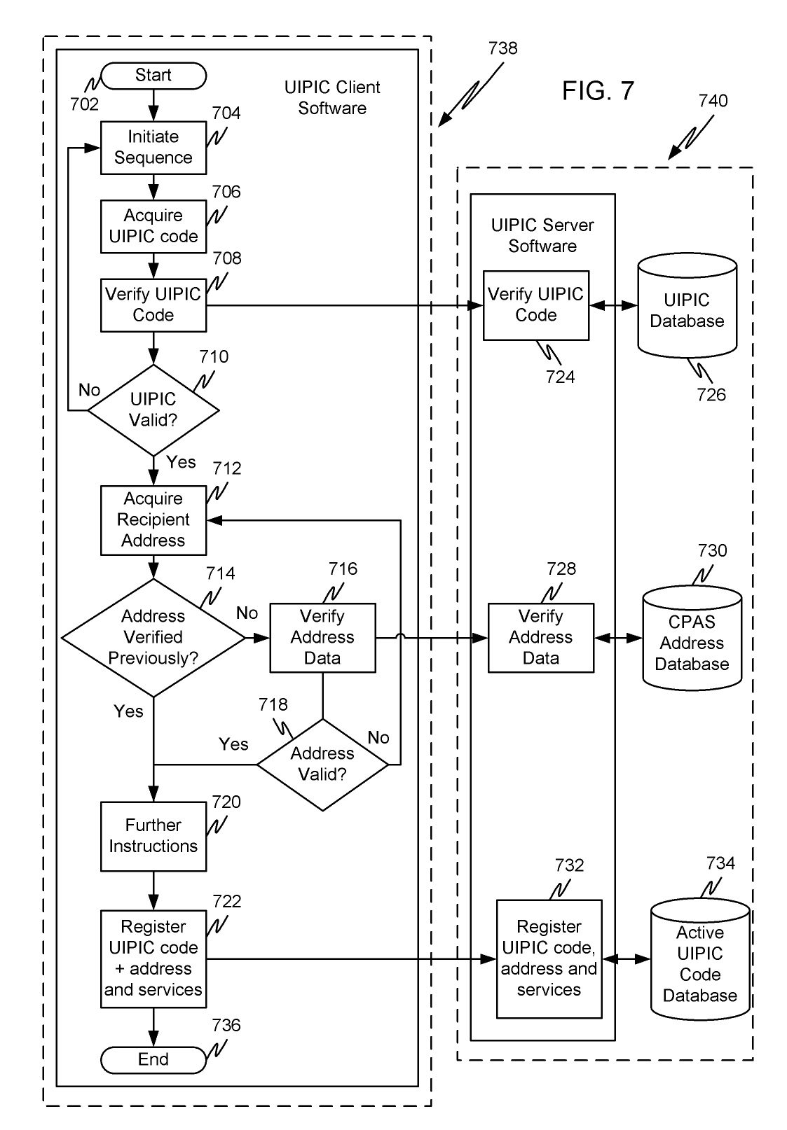

FIG. 7 shows a flowchart for an exemplary method for sending a mail piece using a pre-existing UIPIC code. Processing begins at step 702 and continues to step 704.

In step 704, the UIPIC mailing sequence is initiated by a user. For example, the user could start the UIPIC application program on the user's wireless device. Processing continues to step 706.

In step 706 the UIPIC code from a mail piece is acquired from the mail piece and decoded. As mentioned above, the UIPIC code can be acquired using an imaging device or can be manually input via an input device. Processing continues to step 708.

In step 708, the UIPIC client software (or application program) verifies the UIPIC code by communicating with the UIPIC server 724. The UIPIC server verifies the UIPIC code supplied by the user device by looking up the code in a UIPIC code database 726. The UIPIC server sends a response back to the user device indicating whether the UIPIC code was verified or not. Processing continues to step 710.

In step 710, the UIPIC application program determines whether the response from the UIPIC server indicates a valid code. If the UIPIC code is valid, then processing continues to step 712. Otherwise, processing returns to step 704 and the sequence is re-initiated.

In step 712, a recipient address is acquired. The recipient address can come from user input or from a contact list or other source as discussed below. Processing continues to step 714.

In step 714, it is determined whether the recipient address has ever been verified. If the recipient address has been verified, then processing continues to step 720. Otherwise processing continues to step 716.

In step 716, the recipient address data is verified with the UIPIC server. The UIPIC client software transmits the recipient address data to the UIPIC server to verify the address data 728. The address data can be verified by comparing it against address data stored in a CPAS (or other equivalent database in the destination country) 730. The UIPIC server sends back a response indicating whether the address data is valid. Processing continues to step 718.

In step 718 it is determined whether the response form the UIPIC server indicates that the destination address is valid. If the address is valid, processing continues to step 720. Otherwise processing continues to step 712.

In step 720, the UIPIC client software can query the user to determine if further instructions or additional services are desired for this mail piece. Processing continues to step 722.

In step 722, the UIPIC code and recipient address are registered with the UIPIC server along with any additional services that have been requested by the user. The registration is accomplished by the UIPIC client software sending the UIPIC code, recipient address and any additional services to the UIPIC server. The UIPIC server can create or update a database record associated with the UIPIC code to register the connection between UIPIC code and recipient address 732. The registration information can be stored in a UIPIC active code database 734. Processing continues to step 736, where processing ends.

It will be appreciated that steps 702-736 can be repeated in whole or in part to accomplish a contemplated UIPIC mailing task. Also, the UIPIC client software is executing on a UIPIC enabled computing device 738, while the UIPIC server software is executing on a UIPIC clearinghouse controlled computer system 740.

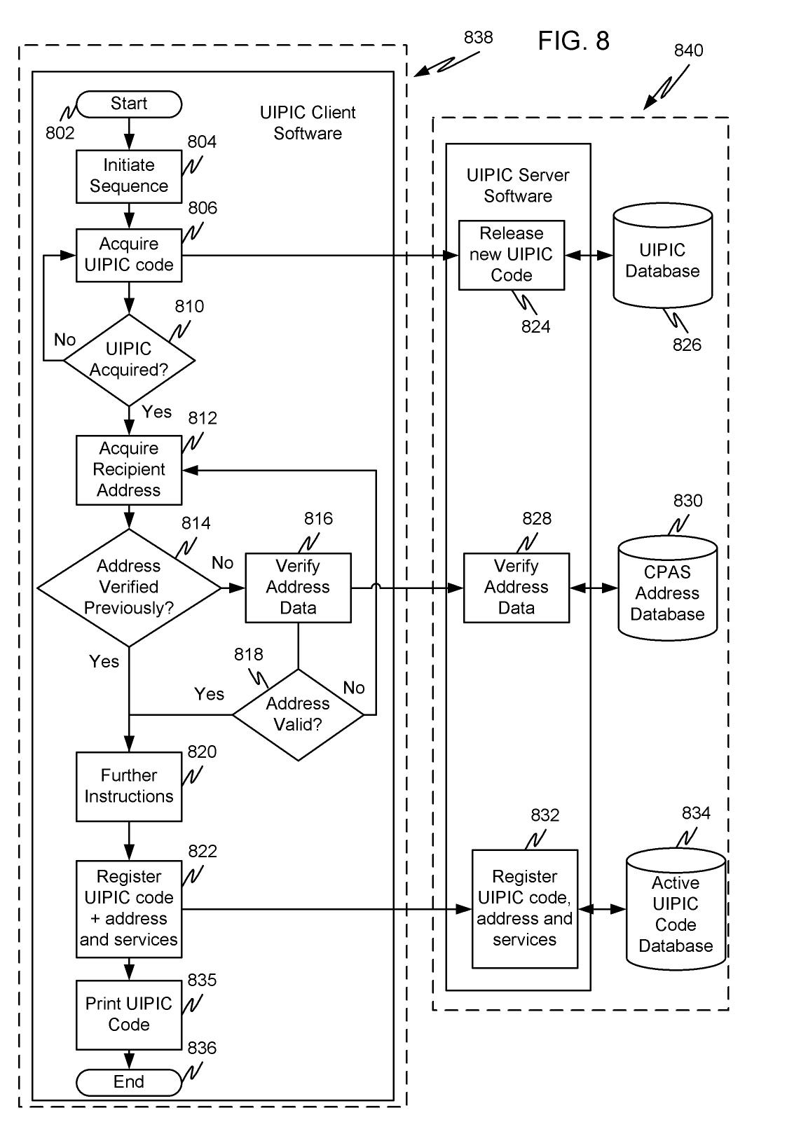

FIG. 8 shows a flowchart for an exemplary method for sending a mail piece when a new UIPIC code needs to be obtained. Processing begins at step 802 and continues to step 804.

In step 804, the UIPIC mailing sequence is initiated by a user. For example, the user could start the UIPIC application program on the user's wireless device. Processing continues to step 806.

In step 806, a new UIPIC code is acquired from the UIPIC server or from a pre-acquired UIPIC code. The UIPIC server 824 can obtain and release a new UIPIC code from the UIPIC code database 826. Processing continues to step 810.

In step 810, the UIPIC application program determines whether the UIPIC code has been acquired. If the UIPIC code has been acquired, then processing continues to step 812. Otherwise, processing returns to step 804 and the sequence is re-initiated.

In step 812, a recipient address is acquired. The recipient address can come from user input or from a contact list or other source as discussed below. Processing continues to step 814.

In step 814, it is determined whether the recipient address has ever been verified. If the recipient address has been verified, then processing continues to step 820. Otherwise processing continues to step 816.

In step 816, the recipient address data is verified with the UIPIC server. The UIPIC client software transmits the recipient address data to the UIPIC server to verify the address data 828. The address data can be verified by comparing it against address data stored in a CPAS (or other equivalent database in the destination country) 830. The UIPIC server sends back a response indicating whether the address data is valid. Processing continues to step 818.

In step 818 it is determined whether the response from the UIPIC server indicates that the destination address is valid. If the address is valid, processing continues to step 820. Otherwise processing continues to step 812.

In step 820, the UIPIC client software can query the user to determine if further instructions or additional services are desired for this mail piece. Processing continues to step 822.

In step 822, the UIPIC code and recipient address are registered with the UIPIC server along with any additional services that have been requested by the user.

The registration is accomplished by the UIPIC client software sending the UIPIC code, recipient address and any additional services to the UIPIC server. The UIPIC server can create or update a database record associated with the UIPIC code to register the connection between UIPIC code and recipient address 832. The registration information can be stored in a UIPIC active code database 834. Processing continues to step 835.

In step 835, a UIPIC code is printed directly on the mail piece or on a label. Alternatively or additionally, an identification device, such as an RFID tag can be programmed with the information. Processing continues to step 836, where processing ends.

It will be appreciated that steps 802-836 can be repeated in whole or in part to accomplish a contemplated UIPIC mailing task. Also, the UIPIC client software is executing on a UIPIC enabled computing device 838, while the UIPIC server software is executing on a UIPIC clearinghouse controlled computer system 840.

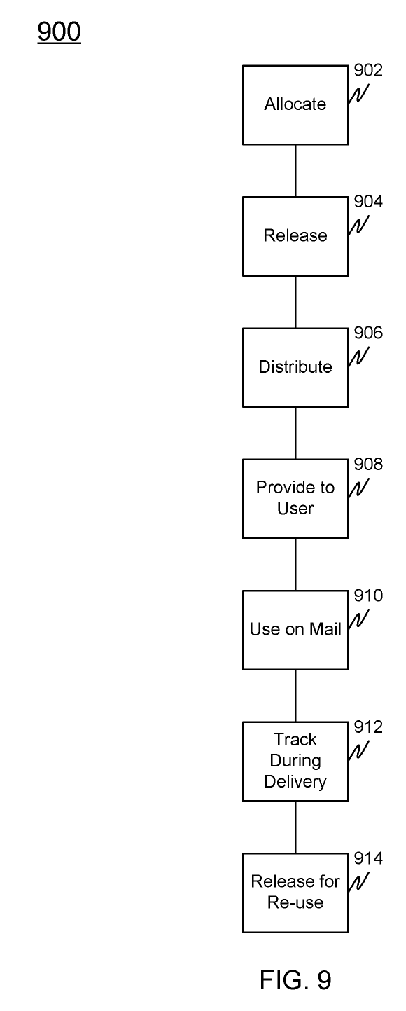

FIG. 9 shows a diagram of an exemplary lifecycle for a UIPIC code. In particular, lifecycle 900 includes allocating UIPIC codes 900. UIPIC codes may be allocated by a UIPIC governing body. For example, the UIPIC codes can be allocated to participating nations or organizations according to demand for the UIPIC codes. The UIPIC governing or administrative body can also decide to allocate codes to private organizations such as private parcel carriers, businesses, or any other organization requesting UIPIC codes.

Once one or more UIPIC codes have been allocated, the allocated UIPIC codes can be released 904 from the master or central UIPIC code database and marked in that database as being in use with possibly an indication of the entity to which the codes have been allocated.

The released codes can be distributed 906 to the entity that requested them. Distribution can include one or more levels or layers of distribution, for example, a postal authority may receive a block of UIPIC codes that may be distributed within a nation by the postal authority.

Once the UIPIC codes have been distributed, they can be provided to a user 908. The user can use the UIPIC codes on mail 910. The UIPIC codes are then tracked during the delivery process 912 and can be released for re-use 914 upon completion of delivery. Releasing could include returning the UIPIC code to the UIPIC governing body or retaining the UIPIC codes at the national level or other sub-level (e.g., retained by business using the code). By releasing the UIPIC codes for re-use, they are marked as not being assigned to a mail piece and can therefore be assigned to a new mail piece as needed.

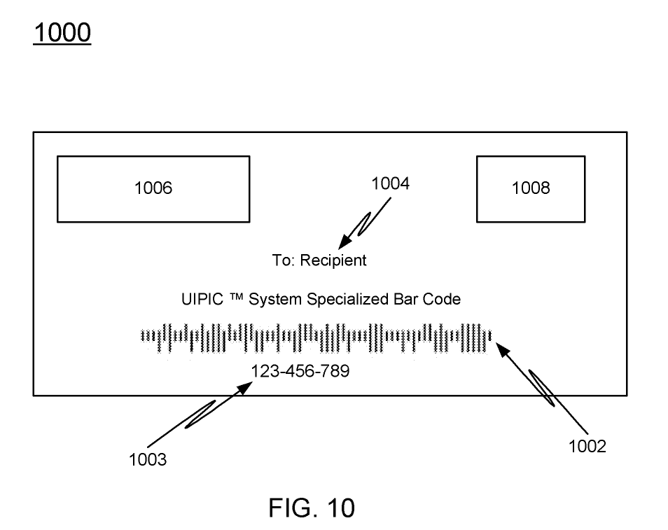

FIG. 10 shows an exemplary UIPIC-enabled mail piece 1000. The mail piece 1000 includes a machine-readable UIPIC barcode 1002, a human-readable portion 1003, an optional recipient name line 1004, an optional return address 1006 and an optional postage indicium 1008.

As described above, the UIPIC barcode 1002 represents a unique identification number (or UIPIC code). The UIPIC code or a corresponding code can be provided in human readable form as well, i.e., the human-readable portion 1003. The human-readable form can be alphanumeric and presented in Arabic numerals, English letters, and/or symbols, or in the letters, numbers or symbols of any language suitable for use as the human-readable portion. The UIPIC code can be any length suitable for use with a contemplated embodiment. For example, the UIPIC code could be an alphanumeric string of sufficient length to provide enough combinations to accommodate the number of mail pieces sent annually by participating entities for a predetermined number of years (e.g., a code having about 29 alphanumeric characters). Because the UIPIC code is unique, it may be used as a mail piece identification number, thus making it possible to avoid applying a mail piece identification number or symbol to the mail piece itself for mail processing or delivery purposes. This can result in a cost savings by avoiding the recurring cost of labeling materials (ink, labels, etc.) for the mail piece identification numbers. Also, by allowing for UIPIC codes to be used on flats and parcels, the need for applying a mail piece identifier to flats and parcels (which is typically a difficult task due to size and shape variation in flats and parcels) can be avoided.

To be used for mailing, the UIPIC code must be associated with a recipient address. The association can occur as a user is preparing the mail piece for mailing, or the UIPIC code can be pre-associated with the mail piece (e.g., in the case of a business return mail piece the UIPIC code can be pre-associated with the address of the business). The UIPIC information on an envelope or mailer can include the UIPIC barcode 1002 and also can include informational messages (such as the one shown indicating that the barcode is a UIPIC barcode), instructional messages on how to handle or process UIPIC mail, or a human readable version of the UIPIC code (1003) making it possible for a sender without access to an imaging device to enter the UIPIC code using a non-image input method and still be able to benefit from the UIPIC delivery system.

The recipient name line 1004 is optional and may be used to help identify a recipient of the mail piece or route the mail piece once it reaches a delivery address. The return address 1006 is, of course, optional and may be hand written, machine printed, or may itself be a UIPIC barcode that has been associated with the desired return address of the sender. Also, a single UIPIC code may be associated with both a delivery point address and a return address, where a UIPIC server can select the appropriate address for a sorting process based on whether a mail piece is being sorted for delivery to the delivery point or is being sorted for return to sender, and as such a separate return address may not be needed on a mail piece.

The postage indicium 1008 is also optional. As mentioned above, because the UIPIC system can have knowledge of the mail sender, it is possible for the sender to establish an account from which postage costs can be debited from. For example, a mailer could establish a deposit account with the post office, could associate a credit card, debit card, or bank account with the mailing account, or could be billed for postage on a periodic basis. Thus, UIPIC enabled mail does not necessarily need to have postage applied to it in order for it to be mailed. This can make is possible for a mailer or sender to avoid purchasing stamps or other postage in advance or in cases where it may be inconvenient to obtain postage. In another embodiment, each UIPIC-enabled mail piece or label could be associated with a base postage amount that can be charged for the UIPIC mail piece or label. Once a particular UIPIC mail piece is received by the mail processing entity (e.g., post office, private shipper, or the like) an actual postage amount can be determined and the mailer's account can be adjusted, if needed.

For example, UIPIC code labels may be purchased at the standard first-class letter rate. Then, the purchaser may apply a UIPIC code label to a post card and mail the post card. When the post card is processed by the mail processor, the user's account may be credited with the difference between the first-class letter rate and the post card rate, if any. In another example, the purchaser may place a UIPIC code label on a parcel. Once the mail processing entity determines the actual postage for the parcel the mailer's account can be debited or credited as appropriate. By requiring some initial payment for a UIPIC code, a postal authority or other organization can generate immediate revenue for the distribution of the UIPIC code labels or mail pieces. Improved profits may result from UIPIC code labels or mail pieces that have been paid for at the base rate, but which are never used. By requiring some initial payment for a UIPIC code, it may make it possible for users not to request more UIPIC codes than they intend to use.

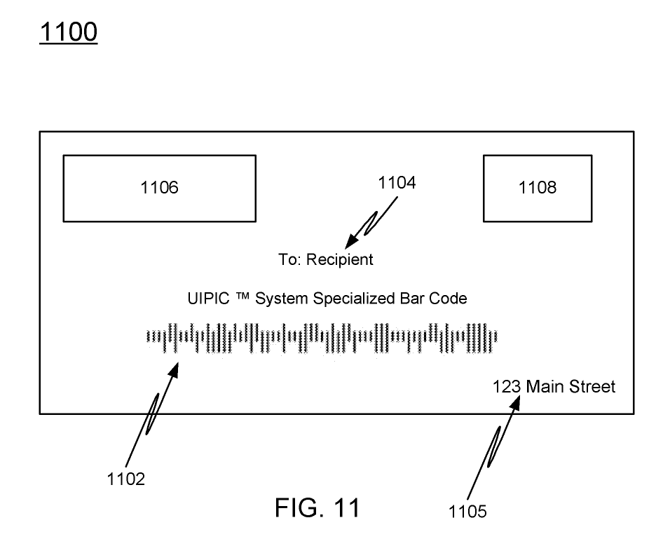

FIG. 11 shows a diagram of a UIPIC-enabled mail piece that includes an address presentation portion. In particular, items 1102-1104 are similar to items 1002-1004 as described above with respect to FIG. 10. The mail piece 1100 of FIG. 11 includes an address presentation portion 1105.

The address presentation portion 1105 is provided for the convenience of the mail carrier so that the delivery address is visible on the mail piece. The address presentation portion 1105 can be applied by a sorting machine. For example, a traditional mail processing machine could be modified to include the capability of spraying (or printing or applying via label) the face of the mail with a portion of the recipient address (likely the street line) so that a mail carrier can view the recipient address and delivery can be facilitated.

In one embodiment of a UIPIC-enabled mail piece, the mail piece envelope can be re-usable. For re-usable envelopes, the address presentation portion 1105 can be applied using a process that results in a temporary display or a changeable display of the address. The address presentation portion may be applied with a temporary ink that will degrade over time (or can be subjected to a process) and will no longer be visible.

Toshiba (Japan) has developed an erasable ink (called “e-blue”) that can be printed on paper using a laser printer or a pen. The ink can be erased by subjecting the paper to an erasing process that involves heat. Such an erasable ink could be used for printing the address line (or other information for which temporary display is desired) on UIPIC-enabled reusable mailers. Another example of erasable or temporary ink is the thermal-sensitive ink that can be erased using the heat of friction generated from rubbing the ink.

Linx Printing Technologies has developed “Blackwater” erasable ink No. 1035 that is removable with water. This type of ink may be useful for UIPIC-enabled reusable mailers that are made of a water-resistant material (such as the Tyvek-type envelopes in use by many mailing and shipping services today).

In another embodiment, UIPIC-enabled reusable mailers could be equipped with a so-called electronic-ink (or e-ink) display device currently being manufactured by E-Ink of Cambridge, Mass. The e-ink device could be configured to display the recipient street line by the user or by the mail processing equipment. When being reused, the process would occur and the e-ink could be reconfigured to display the next recipient street line. By having an e-ink display section based on pixels or other display elements that could be selectively enabled, the e-ink equipped UIPIC-enabled mailers could be used in a variety of languages. The power source for energizing the e-ink display panel could be recharged during the mail sorting process.

Another option for temporary ink includes an ink infused with nanoparticles, which after exposure to light or air will decay and render the ink invisible. The nanoparticles should have a defined and well-known decay time. Alternatively, the ink may not become invisible on its own, but may require exposure to special resetting energy field (e.g., heat, specific light frequency, magnetic field, etc.).

In general, any now known or later developed erasable ink, temporary ink, erasable graphite, or other erasable or temporary writing medium or reconfigurable or changeable electronic display device may be used to present the address portion on a reusable UIPIC mailer. Alternatively, the MPE could be modified to spray or print the address information in the clear zone using conventional, permanent ink. A re-usable UIPIC mailer may need to include a re-sealable closure.

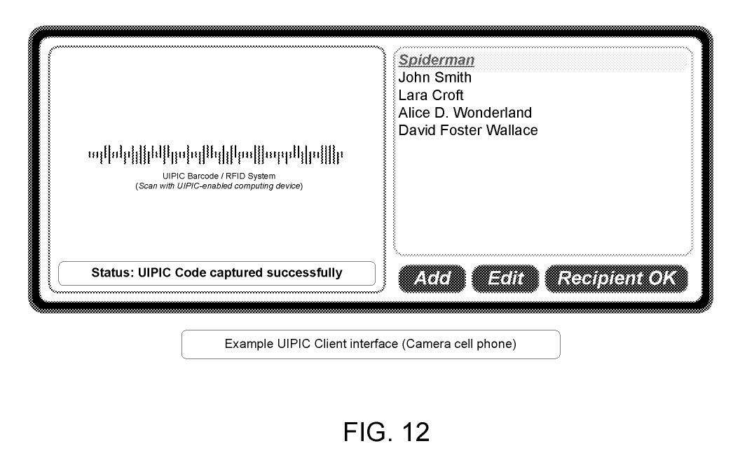

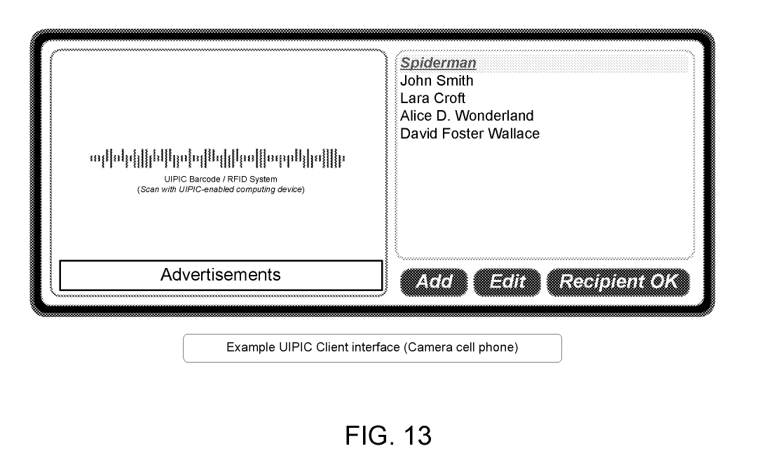

FIGS. 12 and 13 show examples of the UIPIC application user interface. These are examples of screens that a user may view on their handheld device when preparing to mail a UIPIC mail piece. The user interface includes a UIPIC code display section that can include displaying the image taken of the UIPIC barcode, a status indicator as to whether the UIPIC barcode has been successfully captured and decoded.

The user interface also includes a list of contacts which can be selected as a recipient. The list of contacts can also include an indication of those contacts with verified addresses. The user interface includes an “Add” button that is used for adding a recipient. The “Edit” button can be selected to edit the information of a contact. The “recipient OK” button can be used to select a contact as the recipient to be associated with the UIPIC code that has been captured.

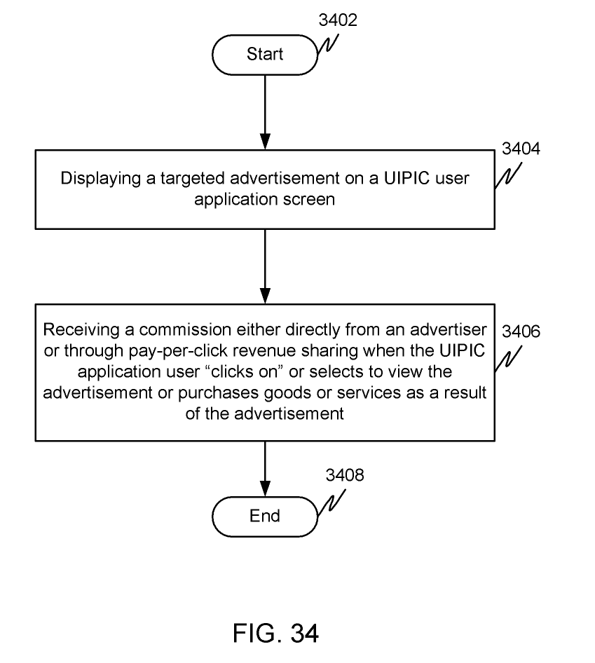

FIG. 13 includes an advertising display portion. This is a portion of the display that could be dedicated for displaying advertisements as a method of offsetting any costs associated with the UIPIC system and/or for generating profits from the UIPIC system. Methods of generating revenue from the advertisements are described in greater detail below in connection with FIG. 34.

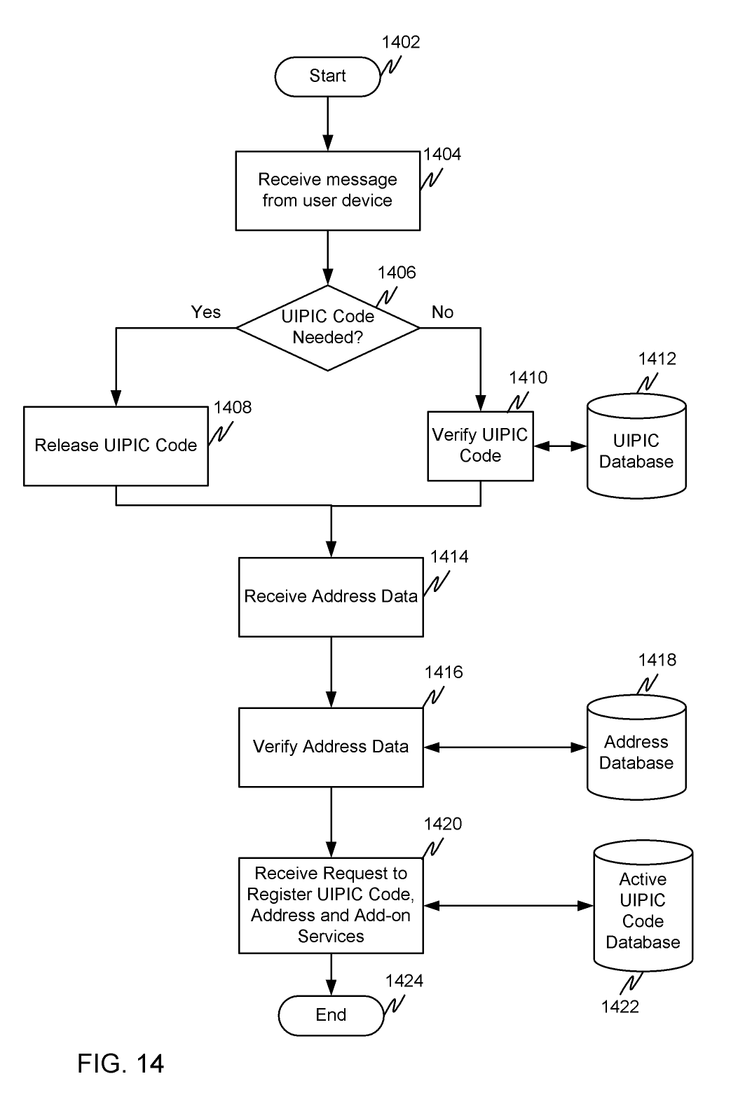

FIG. 14 is a flowchart of an exemplary method of UIPIC server operation when receiving a request from a user device for registering a UIPIC-enabled mail piece. Processing begins at step 1402 and continues to step 1404.

In step 1404, the UIPIC server receives a message from the user device application program. The message can contain a request to obtain or verify a UIPIC code as part of a user's attempt to register a new UIPIC code for a mail piece. Processing continues to step 1406.

In step 1406, the UIPIC server determines, based on the received message, whether a UIPIC code is needed. If so, processing continues to step 1408. Otherwise, processing continues to step 1410.

In step 1408, a new UIPIC code is released by the system for use by the user. Because this code is being released by the UIPIC server, it is possible to avoid the UIPIC code verification step. Processing continues to step 1414.

In step 1410, the UIPIC code received in the message from the user device is verified by checking the status of the code against the UIPIC database 1412. Once the code is verified, processing continues to step 1414. If the code was not able to be verified, the UIPIC server could return a message to the user device indicating the verification status of the UIPIC code.

In step 1414, address data is received from the user device. The address data can be received in a separate message from the UIPIC code or may have been received as part of the initial message in step 1404. Processing continues to step 1416.

In step 1416, the address data is verified by comparing the address data to data from an address database 1418 (e.g., a CPAS database or the like). This step makes it possible to effectively shift the address verification operation that is conventionally done by a mail processing center and often during a sorting operation to the user at mailing time so that a mail piece can be deposited for delivery that is both machine readable (the UIPIC barcode) and has a verified address associated with the barcode prior to the initial processing by the mail or postal processor. Conventionally, mail pieces being sent by individuals are handwritten and thus present address recognition challenges for mail sorting equipment. Furthermore, mail pieces from individuals are typically not pre-barcoded prior to depositing the mail for delivery.

If the address is verified as received, the UIPIC server can send an acknowledgement indicating a verified address was received. However, if there is some ambiguity or reason the address as received cannot be verified, then the UIPIC server can communicate with the user device and attempt to resolve the address to one that can be verified. Processing continues to step 1420.

In step 1420, the UIPIC server receives a request to register the UIPIC code, the verified address, and any additional services requested by the user. This information is recorded in an active UIPIC code database 1422. It should be appreciated that databases 1412 and 1422 could be the same database or could be different databases or tables within a database. Processing continues to step 1424, where processing ends. It should be appreciated that some or all of the above steps can be repeated to perform a contemplated UIPIC server operation.

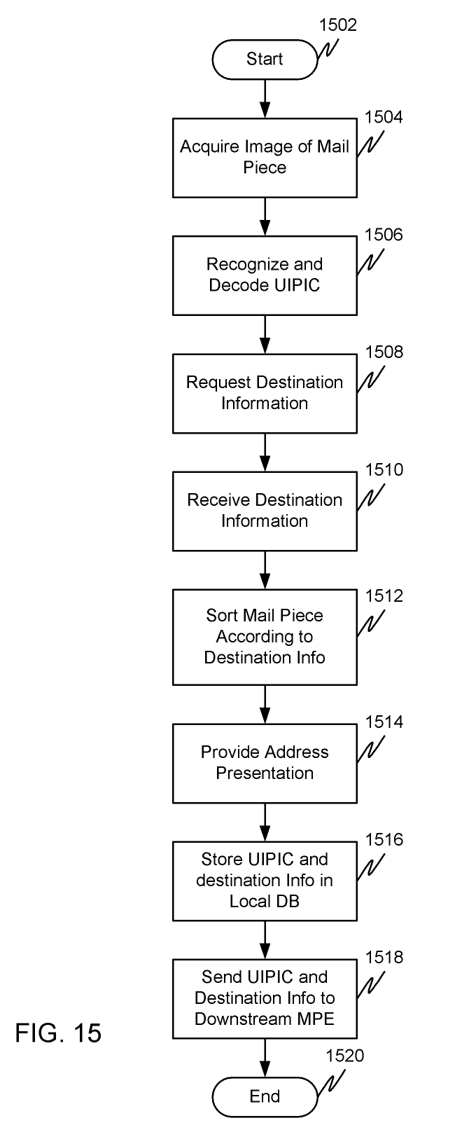

As will be discussed below, FIG. 15 shows a flowchart of an exemplary method of operating a UIPIC mail processing system. In addition to the methods described above and below, an embodiment can also include an optional push of data from a UIPIC server to one or more local-to-sender mail processing centers. The data push can occur immediately after a UIPIC code and address have been paired (or associated) by a user, or can occur at a later time. In order to make it possible to reduce UIPIC code lookup latency times, the UIPIC server can send the paired data out to all postal mail centers within a predetermined (e.g., 100 mile radius) distance from a senders location (e.g., where the sender lives or where the sender is presently located based on GPS or location system data). By receiving the paired UIPIC data in advance, a mail processing center may retrieve the UIPIC data from a local database that can be smaller as compared to the active UIPIC code database and may be accessed using a faster connection than a remote database. Also, after the first successful read of the mail piece by a mail processing center, the UIPIC server can receive notification that the mail piece has been initially processed by a mail processing center and can send a notification to the other centers that had received the paired data to delete the record from their respective databases, thereby reducing the amount of data stored in those databases and making it possible to reduce lookup latency.

In FIG. 15, processing begins at step 1502 and continues to step 1504.

In step 1504, an image of a UIPIC mail piece is acquired. This can be performed using conventional equipment configured to read UIPIC barcodes or can be performed using specialized equipment designed for UIPIC barcodes. Processing continues to step 1506.

In step 1506, the UIPIC barcode on the mail piece is recognized and decoded. Processing continues to step 1508.

In step 1508, the mail processing system requests destination (or recipient) information corresponding to the UIPIC code from the UIPIC server. Processing continues to step 1510.

In step 1510, the UIPIC mail processing system receives the destination information from the UIPIC server. Once the destination information is received, the mail piece can be sorted according to the destination 1512. Processing continues to step 1514.

In step 1514, an address presentation can optionally be applied to the mail piece (as described above). Processing continues to step 1516.

In step 1516, the UIPIC code and associated destination information can optionally be stored locally. By storing the UIPIC code and destination information locally, the UIPIC mail processing system can make it possible to reduce latency during multi-pass sorting operation by providing a copy of the destination information in a local database that may be faster to access than the UIPIC server and its database. Processing continues to step 1518.

In step 1518, the UIPIC code and associated destination information can be sent to another mail sorting system at the same or a different facility. The other mail sorting system can be selected based on the destination information. For example, a UIPIC processing system on the east coast may process a UIPIC mail piece destined for California and receive the destination information from the UIPIC server. The east coast processing center could forward a data record containing the UIPIC code and destination information to the processing center on the west coast associated with the destination of the mail piece. Thus, the west coast center may benefit from having a local copy of the UIPIC destination information and may be able to reduce a look up time as described above. Processing continues to step 1520, where processing ends. It will be appreciated that the steps shown in FIG. 5 may be repeated in whole or in part in order to accomplish a contemplated UIPIC mail sorting task.

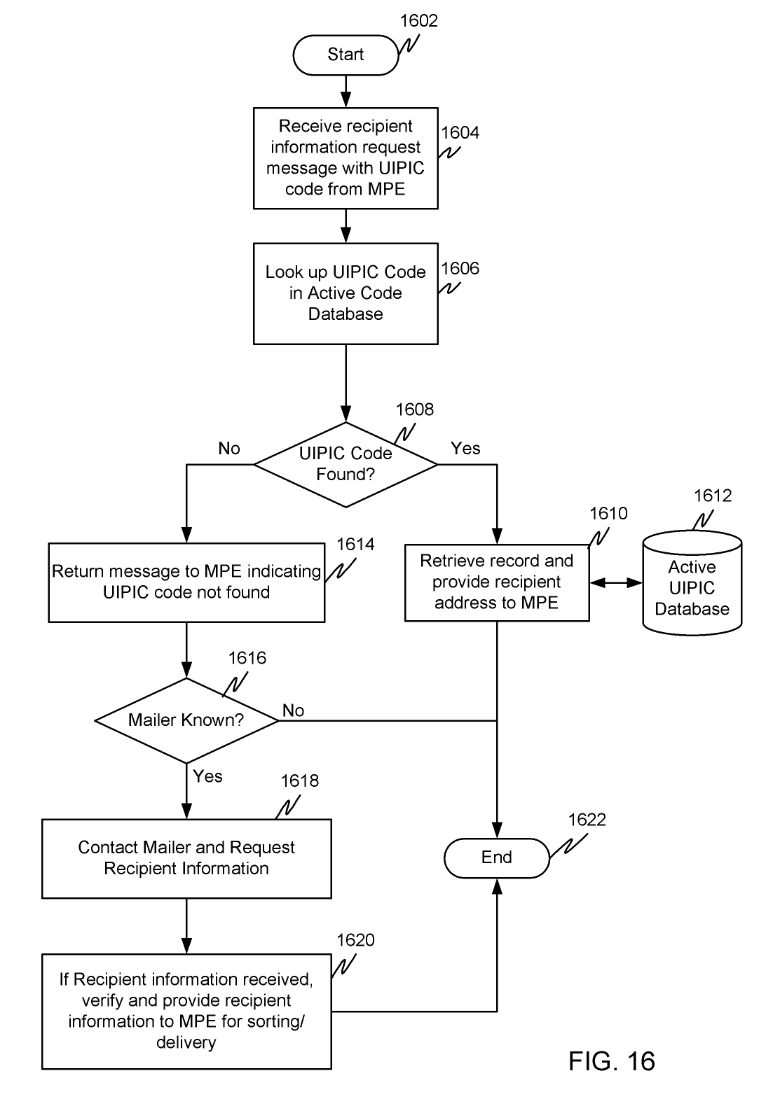

FIG. 16 shows a flowchart of an exemplary UIPIC server method of operation during UIPIC mail sorting. Processing beings at step 1602 and continues to step 1604.

In step 1604, the UIPIC server receives a request from a piece of mail processing equipment (MPE) or a mail processing center containing a UIPIC code and requesting recipient (or destination) address information to be used for sorting. Processing continues to step 1606.

In step 1606, the UIPIC server looks up the UIPIC code in the UIPIC active code database. Processing continues to step 1608.

In step 1608, the UIPIC server determines whether the UIPIC code was found in the database. If the code was found processing continues to step 1610. If the code was not found then processing continues to step 1614.

In step 1610, the UIPIC database record associated with the received UIPIC code is retrieved from the UIPIC active code database 1612. Processing continues to step 1622, where processing ends.

In step 1614, the UIPIC server returns a message to the MPE or MPC that the UIPIC code was not found. Processing continues to step 1616.

In optional step 1616, the UIPIC server attempts to determine if a mailer associated with the UIPIC code is known. This can include using knowledge of which UIPIC codes have been sold to which customers to identify a likely owner of the code that was not present in the active database. If the mailer is known, then processing continues to step 1618. Otherwise processing continues to step 1622, where processing ends.

In optional step 1618, the UIPIC server contacts the likely mailer (e.g., via email or text message) and requests recipient information for the UIPIC code not in the active database. Processing continues to step 1620.

In optional step 1620, if recipient information is received from the user, then it can be verified, stored in the UIPIC active code database, and provided to the MPE/MPC for sorting. Processing continues to step 1622, where processing ends. It will be appreciated that the steps of FIG. 16 can be repeated in whole or in part in order to accomplish a contemplated UIPIC server task.

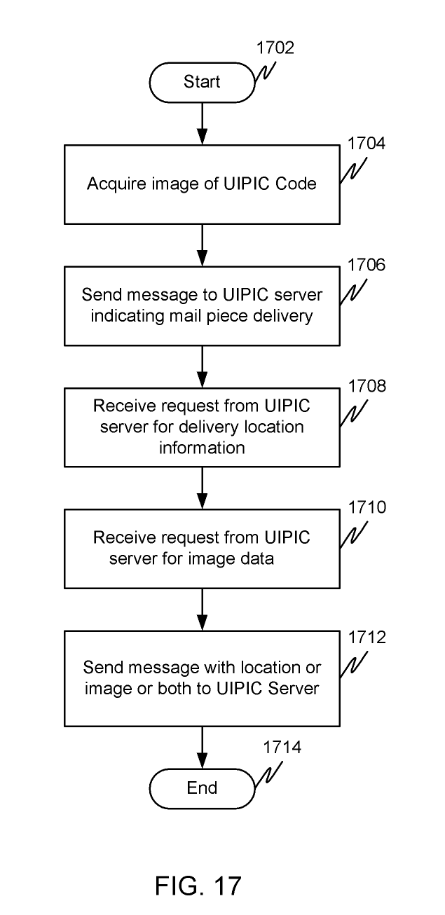

FIG. 17 is a flowchart of an exemplary UIPIC mail delivery sequence for a mail carrier device. Processing begins at step 1702 and continues to step 1704.

In step 1704, the mail carrier acquires an image of the UIPIC mail piece using a mail carrier device (which could be one of the types of devices listed above or could be a specialized mail delivery device). Processing continues to step 1706.

In step 1706, the mail carrier device (via a mail carrier application program running on the device) sends a message to a UIPIC server indicating mail piece delivery and containing the UIPIC code. Processing continues to step 1708.

In optional step 1708, the mail carrier device receives a request for location information and can prompt the mail carrier to indicate to the device that location information may be sent or may automatically provide the location information. The location information can be determined via global positioning system (GPS), other wireless location system, or the like. Processing continues to step 1710.

In optional step 1710, the mail carrier device receives a request for image information and can prompt the mail carrier to indicate to the device that image information may be sent or may automatically provide the image information. The image data can include an image of the mail piece, an image of the delivery location, and an image of a person receiving the mail piece, other image, or a combination of the above. Processing continues to step 1712.

In step 1712, location data or image data or both are sent to the UIPIC server. Processing continues to step 1714, where processing ends. It will be appreciated that the steps shown in FIG. 17 can be repeated in whole or in part in order to perform a contemplated UIPIC mail delivery task.

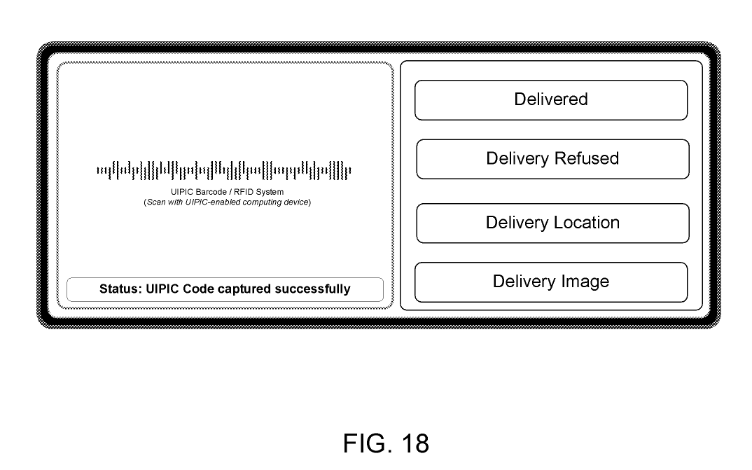

FIG. 18 shows a diagram of an exemplary user interface for a mail carrier device or application program. The left side of the screen can include the acquired image of the UIPIC code and an indication of the status of capturing and decoding the UIPIC barcode. The right side of the screen includes user interface “buttons” that are selectable by the mail carrier for the following: “Delivered” can be used to indicate the mail piece was delivered; “Delivery Refused” can be used to indicate that delivery of the mail piece was refused; “Delivery Location”—can be used to send location information to the UIPIC server; and “Delivery Image”—can be used to send image data to the UIPIC server.

It will be appreciated that an actual implementation of the mail carrier application may includes more or less elements than those shown and may include different elements based on the contemplated implementation details.

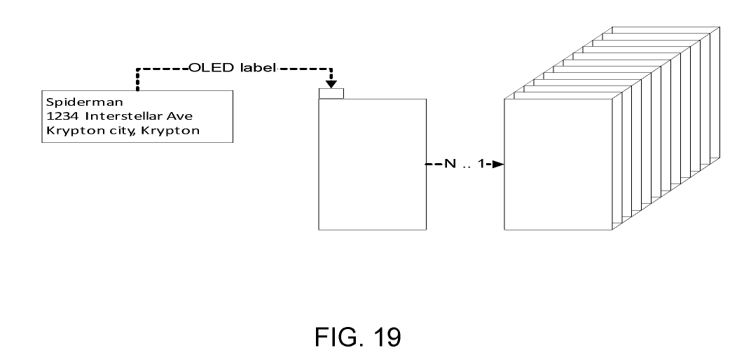

FIG. 19 shows a postal carrier container for delivery of mail that does not include a recipient name and/or address printed on the mail piece. The container can include multiple slots (e.g., each corresponding to a delivery point). Each slot can be equipped with an electronically changeable label display (e.g., an organic light emitting diode (OLED) label, e-ink display, or the like). The label display shows the address for the items of mail in the corresponding slot. In addition to the address, the label display can show a UIPIC barcode associated with a mail piece in the slot. The label display can also show special instructions (e.g., sender recall of mail piece or address redirection) immediately prior to delivery. The scan of the UIPIC code on the label display can trigger the UIPIC server to update the UIPIC code record to indicate that the mail piece was delivered. Other information can be sent at delivery time from the mail carrier device to the UIPIC server including time/date stamp, mail carrier identification, mail carrier device identification, mail carrier device coordinates at delivery time, or the like.

Also, as an added security measure, the location of the mail carrier device can be compared with a location of the recipient address at delivery time and an alert can be raised if the locations differ by more than a predetermined amount.

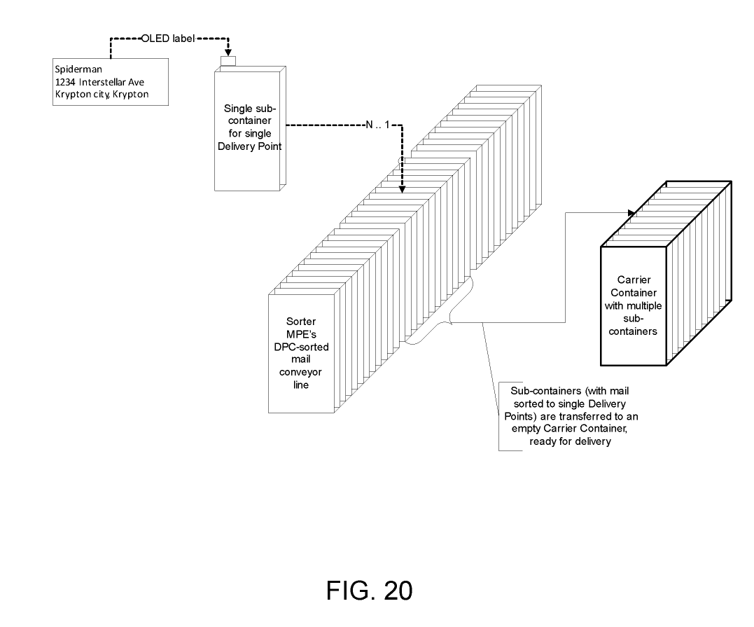

FIG. 20 shows another exemplary embodiment of a delivery container having single delivery point sub-containers. The delivery container can be comprised of a flexible material and be expandable. The delivery container can include one or more removable single delivery point sub-containers (SDPSs). The SDPSs can be removed from the delivery container and placed into a mail sorter for use as sorting endpoints. The sorter MPE can sort mail into the SDPSs. The SDPSs for a single carrier route can then be placed into a delivery container. The number of SDPSs placed into a single delivery container can depend on the width of the SDPSs in relation to the available space in the delivery container.

Each SDPS can include a mechanism for detecting the opening of the top of the SDPS by the mail carrier. The detection of the opening event can cause the delivery container to communicate with the mail carrier handheld device to send delivery confirmation messages for the mail pieces in the SDPS. Optionally, the opening event detection could be paired with location data to prevent non-delivery openings from being reported as delivery confirmations.

The dividers between compartments of the delivery container can be removable, lightweight and flexible. The sorter MPE can sort mail in a conventional method, but inject a divider between mail pieces going to different delivery points. The dividers may or may not have a display device on them.

The delivery container can include a wireless interface (e.g., Bluetooth, WiFi, or the like) or wired connection to allow the delivery container to communicate with the mail carrier handheld device. The act of opening each compartment can be used to trigger a message from the delivery container to the mail carrier handheld device that a delivery has occurred at the corresponding delivery point. The mail carrier handheld device can record date/time, location (e.g., GPS coordinates) and delivery point information and send this information as a message to the UIPIC server for delivery confirmation purposes.

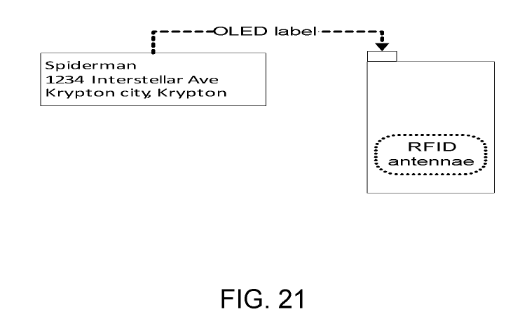

In another embodiment, shown in FIG. 21, an RFID sensing device or antenna can be placed on the wall of each of the compartment dividers of the delivery container so that UIPIC mail (or other mail) with RFID tags can be detected by the delivery container. The delivery container can read the RFID of mail pieces in the container, communicate with the mail carrier handheld to retrieve the recipient address information from the UIPIC server (in the case of UIPIC mail) or from the RFID tag itself (in the case of non-UIPIC mail) and display the recipient address on the label display (e.g., the OLED device). This arrangement can eliminate the need for the sorter MPE to communicate with the delivery container.

The delivery container can be carried upright in a configuration in which the width is shorter than the height (i.e., the mail will be standing on its side and so extend outwardly from a carrier's side less than the vertical extent) and will make it possible to provide an ergonomic mail container for use by the mail carrier. Also, the delivery container can include side opening that allow a sorter MPE to load mail from the side.

An embodiment of the UIPIC system can be used for deferred mailing services. Deferred mailing is a service in which a mail piece is received for delivery at a specific date in the future. The UIPIC codes could be used to track such deferred mailing and allow the sender to adjust the delivery date and also receive notification when the mail piece is delivered.

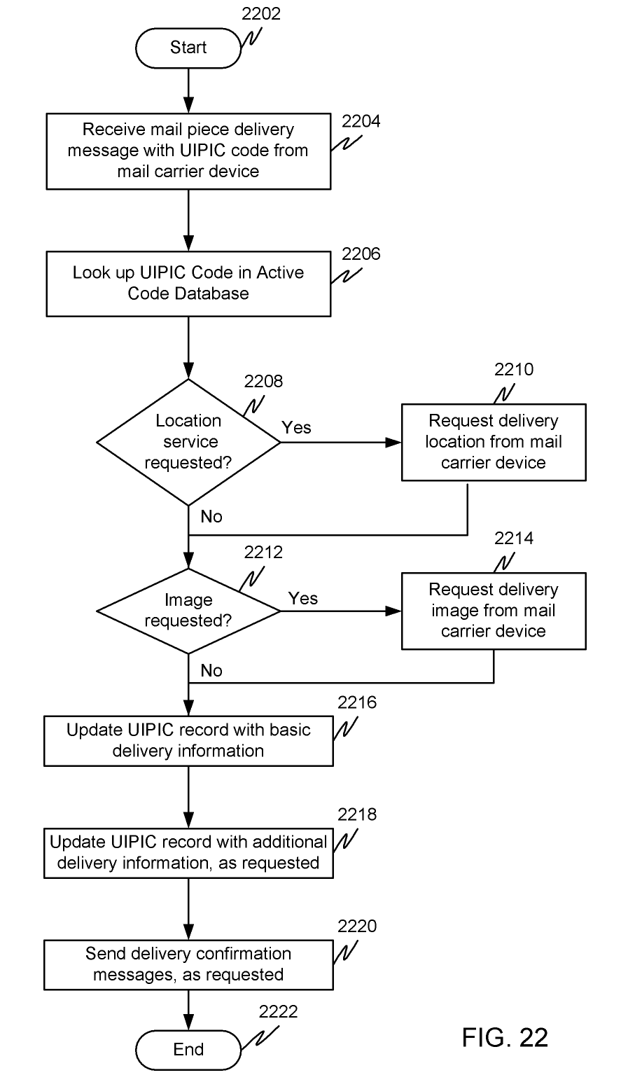

FIG. 22 is a flowchart of an exemplary embodiment of a method for processing delivery information at a UIPIC server. Processing begins at step 2202 and continues to step 2204.

In step 2204, a mail piece delivery message is received from the mail carrier device and includes a UIPIC code (and possibly additional information such as GPS coordinates, time/date, an image, a signature, etc.). Processing continues to step 2206.

In step 2206, the UIPIC code is looked up in the active UIPIC code database. Processing continues to step 2208.

In step 2208, the UIPIC server determines if delivery location confirmation services were requested. If so, processing continues to step 2210 were a location information request message is sent to the mail carrier device. Alternatively, if location information was supplied in the received data along with the UIPIC code, then the request to the mail carrier device may not be sent. Processing continues to step 2212.

In step 2212, the UIPIC server determines if image confirmation services were requested. If so, processing continues to step 2214 were an image information request message is sent to the mail carrier device. Alternatively, if image information was supplied in the received data along with the UIPIC code, then the request to the mail carrier device may not be sent. Processing continues to step 2216.

In step 2216, the UIPIC record in the database is updated with basic delivery information such as time/date, delivery point, and the like. Processing continues to step 2218.

In optional step 2218, additional delivery confirmation information can be stored if available, such as location, image, signature, etc. Processing continues to step 2220.

In optional step 2220, delivery confirmation messages are sent as requested. Processing continues to step 2222, where processing ends. It will be appreciated that steps 2202-2222 may be repeated in whole or in part to accomplish a contemplated UIPIC server delivery confirmation task.

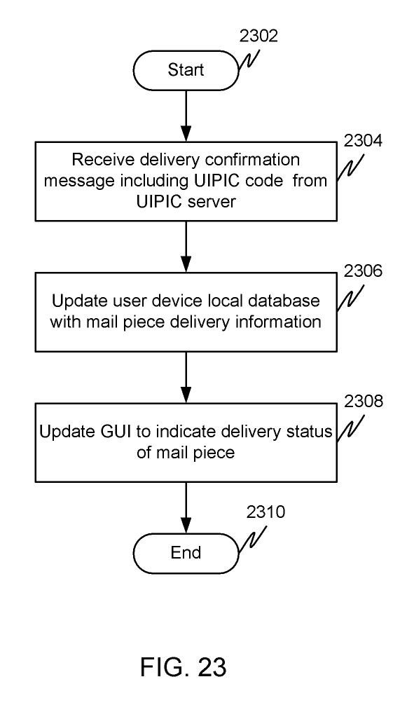

FIG. 23 is a flowchart of an exemplary method of receiving and updating the user device with delivery confirmation information. Processing begins at step 2302 and continues to step 2304.

In step 2304, the user device receives a delivery confirmation message from the UIPIC server including a UIPIC code. Processing continues to step 2306.

In step 2306, the user device updates a local database or list with the delivery confirmation information. Processing continues to step 2308.

In step 2308, the user devices updates the GUI or GUI control parameters to indicate the delivery status of the mail piece associated with the UIPIC code. For example, the UIPIC application program could display delivery status via a color of items in a list or via a symbol shown adjacent to each item in the list on the display. Processing continues to step 2310 where processing ends. It will be appreciated that steps 2302-2310 may be repeated in whole or in part in order to accomplish a contemplated user device delivery confirmation data update task.

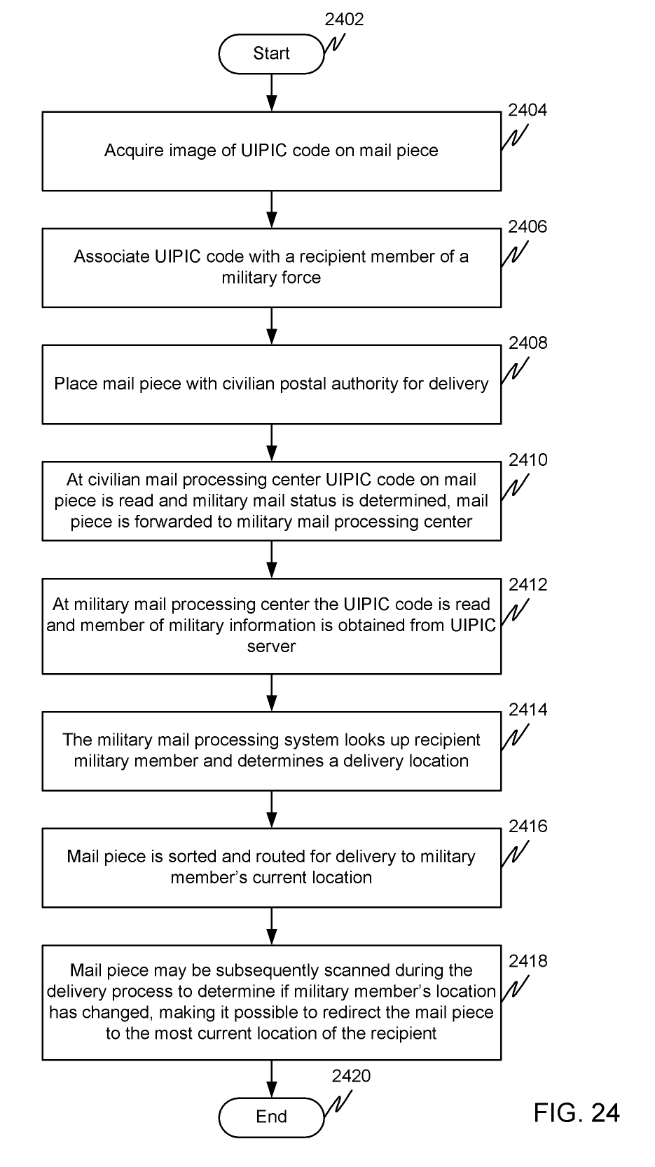

FIG. 24 is a flowchart of an exemplary embodiment of a method for using UIPIC-enabled mail pieces for sending to members of the armed forces or military. Processing begins at step 2402 and continues to step 2404.

In step 2404, an image of the UIPIC code is acquired from the mail piece or UIPIC label. Processing continues to step 2406.

In step 2406, the UIPIC code is associated with a member of the armed forces or military by the user. Because UIPIC-enabled mail pieces do not need to have name or address information printed or written on the mail piece, UIPIC-enabled mail may provide additional confidentiality or security by not disclosing any identity or location information on mail pieces for members of the military. Processing continues to step 2408.

In step 2408, the mail piece is place with a civilian post office for delivery. Processing continues to step 2410.

In step 2410, at a civilian mail processing center, an image of the UIPIC code on the mail piece is captured and decoded, the military mail status is determined, and the mail piece is forwarded to a military mail processing center. Processing continues to step 2412.

In step 2412, at the military mail processing center, the UIPIC code is read from the mail piece and the member of military is obtained from the UIPIC server based on the UIPIC code. Processing continues to step 2414.

In step 2414, the military mail processing system looks up the military member and determines a current location for delivery of the mail piece. Processing continues to step 2416.

In step 2416, the mail piece is sorted and routed for delivery based on the current location. Processing continues to step 2418.

In step 2418, the mail piece may be subsequently scanned during the sorting or delivery process to determine if the military member's location has changed. This can make it possible to redirect the mail piece prior during the delivery process to a current location. Processing continues to step 2420, where processing ends. It will be appreciated that steps 2402-2420 may be repeated in whole or in part in order to accomplish a contemplated military mail delivery task.

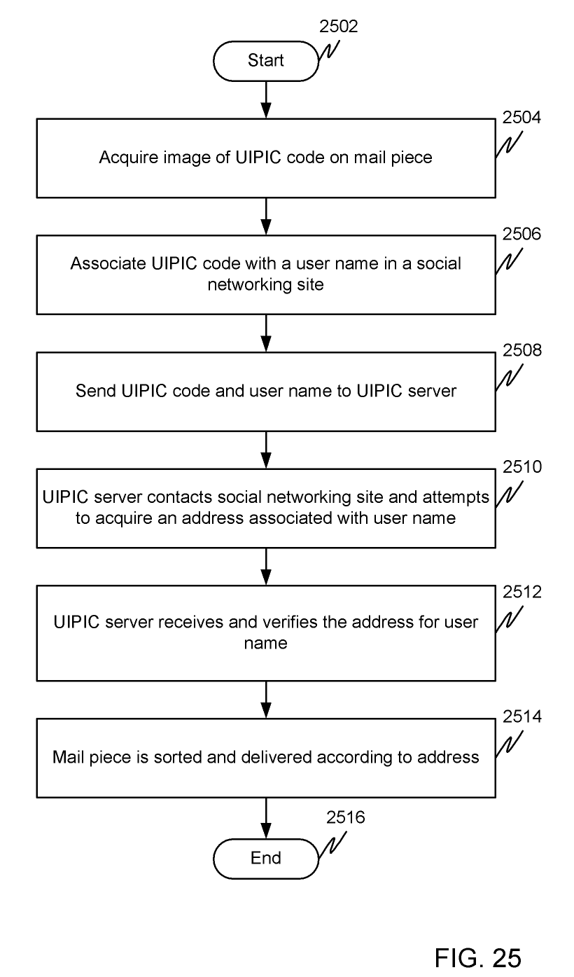

FIG. 25 is a flowchart of an exemplary method for sending UIPIC-enabled mail to a user of a social networking website. Processing begins at step 2502 and continues to step 2504.

In step 2504, an image of the UIPIC code is acquired. Processing continues to step 2506.

In step 2506, the UIPIC code is associated by the sender (or UIPIC user) with a user (or “friend”) on a social networking site. This can be done by accessing the social network site and selecting a “friend” as a recipient. Alternatively, the UIPIC application can access the user's friend list (with permission of the user) and present the friend list for selection by the user. In another alternative embodiment, the user could simply select a participating social networking site and enter the name of the friend. Processing continues to step 2508.

In step 2508, the user sends the UIPIC code and friend (and possibly social networking site) to the UIPIC server. Processing continues to step 2510.

In step 2510, the UIPIC server contacts the social networking site and requests address information for the friend. Alternatively, the UIPIC server can contact the friend through the social networking site and request address information (which can be held confidentially by the UIPIC server) for example through the social networking site communication method, email, text messaging, or the like. Once an address is obtained, processing continues to step 2512.

In step 2512, the received address is verified by comparing the address with a postal authority address database. If the address cannot be verified, the UIPIC server could contact the friend for correction of the address. Processing continues to step 2514.

In step 2514, the UIPIC-enabled mail piece can be sorted and delivered according to the friend's address. This can occur without the user (or sender) knowing the friend's address. The UIPIC system can allow individuals on social networking sites to send each other physical mail items with a level of anonymity similar to that provided by email. Processing continues to step 2516, where processing ends. It will be appreciated that steps 2502-2516 may be repeated in whole or in part in order to accomplish a contemplated social networking friend mailing task.

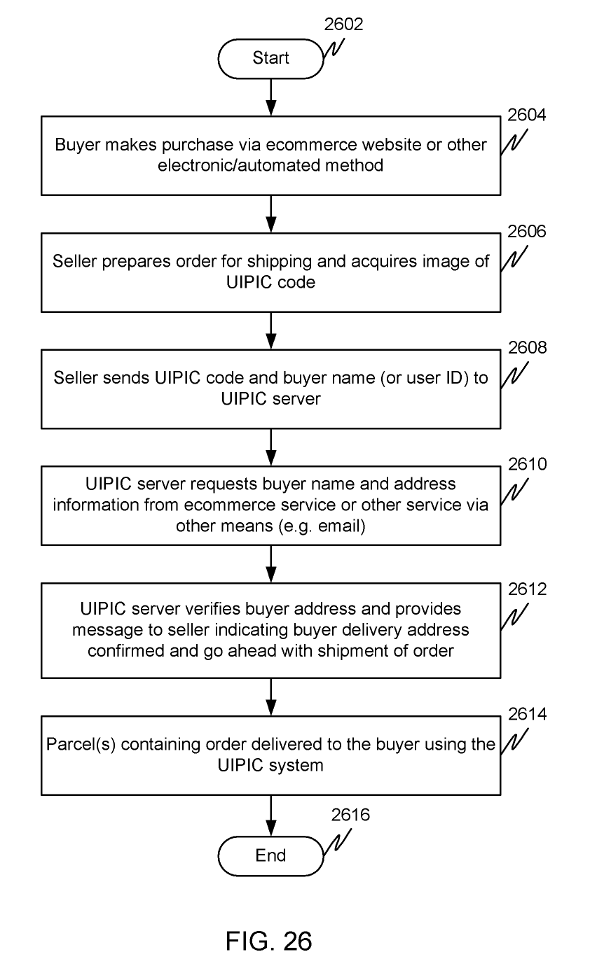

FIG. 26 is a flowchart of an exemplary method for using UIPIC-enabled mail with ecommerce or other electronic automated method (e.g., telephone orders, orders via entertainment devices, etc.). Processing begins at step 2602 and continues to step 2504.

In step 2604, a buyer makes a purchase via ecommerce, telephone, entertainment device (e.g., set top box, wireless device, media player, etc.), but without providing any address information to seller. Processing continues to step 2606.

In step 2606, the seller prepares the order for shipping and acquires an image of the UIPIC code being used for the parcel(s). Processing continues to step 2608.

In step 2608, the seller sends the UIPIC code and buyer name (or user name/purchasing outlet) to UIPIC server. Processing continues to step 2610.

In step 2610, the UIPIC server contacts the ecommerce server or other sales channel server and requests buyer name and address information (which can be held confidentially in the UIPIC server and not available for seller to view). The communication between the UIPIC server and the sales channel can be conducted through a web service, or other electronic communication. Processing continues to step 2612.

In step 2612, the UIPIC server verifies the buyer address information and sends a message to the seller indicating that the buyer's address has been received and confirmed and associated successfully with the UIPIC code on the shipment. Once confirmation has been received, the seller can then place the order in the mail stream or with a carrier for delivery. Processing continues to step 2614.

In step 2614, the parcel(s) containing the buyer's order are delivered to the buyer using the UIPIC system. It should be noted that the UIPIC system makes it possible for a buyer on an ecommerce site (e.g., eBay) to make a purchase without having to provide a physical address to the seller. Processing continues to step 2616, where processing ends. It will be appreciated that steps 2602-2616 may be repeated in whole or in part in order to accomplish a contemplated ecommerce purchase using UIPIC-enabled parcels for delivery.

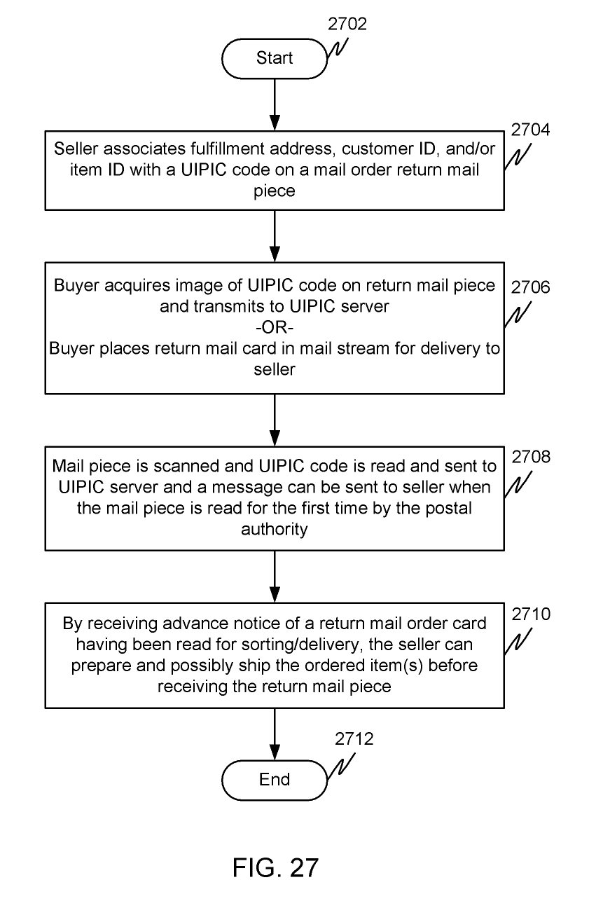

FIG. 27 is a flowchart of an exemplary method for making a mail-order purchase using a UIPIC-enabled return mail piece. Processing begins at step 2702 and continues to step 2704.

In step 2704, a mail-order merchant (or seller) associates a fulfillment address, a customer ID, an item ID or any combination of the above at least including the fulfillment address with a UIPIC code applied to a return mail piece (e.g., an order form postcard). It should be noted in this case that the recipient address has been pre-associated with the UIPIC code and the buyer sending in the mail piece with the UIPIC code on it does not need to associate an address with the UIPIC code. Processing continues to step 2706.

In step 2706, the buyer acquires an image of the UIPIC code on the return mail piece and transmits a message to the UIPIC server that the buyer is making a purchase. The UIPIC server can, in turn, inform the seller and the seller may take steps to fulfill the order even before the return mail piece has been mailed. Alternatively, the buyer can simply make any indication needed on the return mail piece and place the return mail piece in the mail stream for delivery to the seller. Processing continues to step 2708.

In step 2708, the mail piece is scanned during the initial mail sorting process and the UIPIC code is read and a message is sent to the UIPIC server that the UIPIC code has been read on a mail piece. The UIPIC server can send a message to the seller indicating that the order form has been received for delivery. The seller can begin to fulfill the order even before the order form has been delivered to the seller. In addition to the UIPIC information, for commercial mailings such as this, the UIPIC mail processing equipment could provide images of the front and/or back surfaces of the order form mail piece and send one or both images to the UIPIC server for delivery to the seller when the seller is notified of the order form entering the mail system for delivery. By receiving the images it is possible for the seller to ascertain what items and in what quantity have been ordered and prepare the order for shipment with less delay as compared to conventional mail order forms. Processing continues to step 2710.

In step 2710, as mentioned above, when the seller receives advance notice of the order via the UIPIC system, the seller can begin to fulfill the order. Processing continues to step 2712, where processing ends. It will be appreciated that steps 2702-2712 may be repeated in whole or in part in order to accomplish a contemplated UIPIC-enabled mail order processing task.

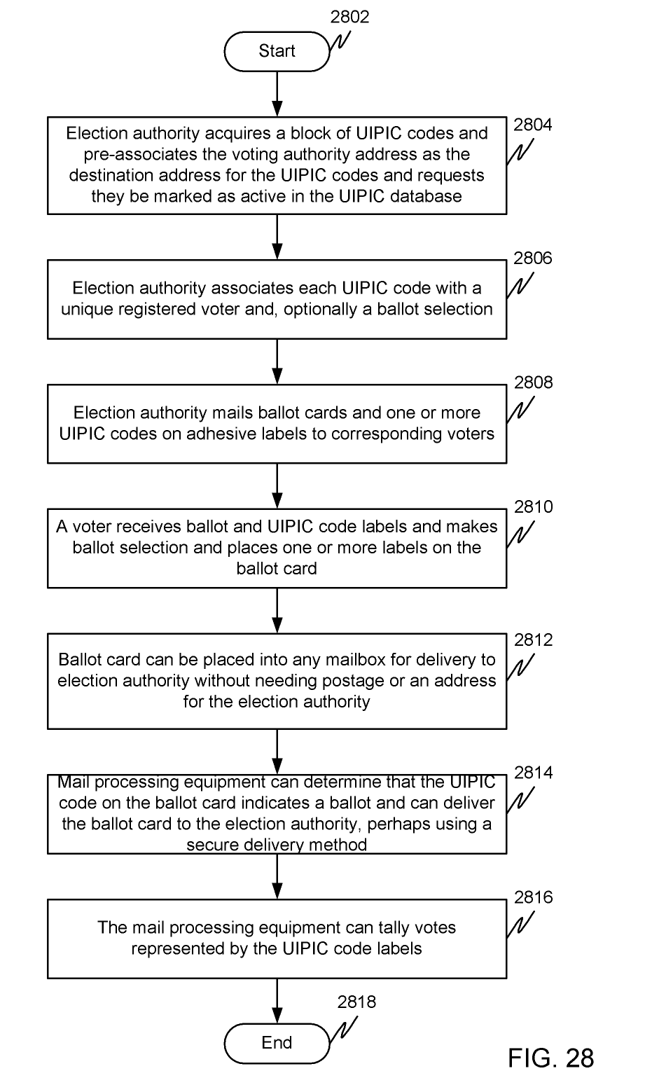

FIG. 28 is a flowchart of a method of voting by mail using UIPIC enabled mail pieces and voting labels. Processing begins at step 2802 and continues to step 2804.

In step 2804, an election authority acquires a block of UIPIC codes and pre-associates the code with the election authority address as the recipient address and requests that the codes be marked as active in the UIPIC server in order to avoid any possible duplicate codes entering the system. Processing continues to step 2806.

In step 2806, the election authority can associate each UIPIC code with a unique registered voter and, optionally, with a ballot choice or selection. Processing continues to step 2808.

In step 2808, the election authority mails out the ballot cards and one or more UIPIC code labels to corresponding voters. Processing continues to step 2810.

In step 2810, a voter receives a ballot card and one or more UIPIC code labels. The voter can vote by placing the UIPIC code labels corresponding to his ballot choices on the ballot card. Because the labels are encoded, the voter's ballot choices are secret even if the UIPIC code labels are externally visible on the ballot card when it is mailed. Processing continues to step 2812.

In step 2812, the ballot card can be placed into any mailbox for return to the election authority. It should be noted that the ballot card does not have to indicate anywhere on the card that it is a ballot card or for what voting are or for what voter. The card can appear as a postcard with one or more barcode labels affixed to it. Processing continues to step 2814.

In step 2814, the mail processing equipment can determine the presence of at least one UIPIC code on the ballot card, look up the UIPIC code via the UIPIC server as described above, and delivery the ballot card to the election authority, perhaps using a secure delivery method. Processing continues to step 2816.

In step 2816, the mail processing equipment can be configured to tally or count the votes from the ballot cards and report the results to the election authority. The votes can be tallied if the UIPIC code labels are associated with a unique voter registration and ballot choice. Processing continues to step 2818, where processing ends. It will be appreciated that steps 2802-2818 may be repeated in whole or in part in order to perform a contemplated UIPIC-enabled mail voting task. Also, the UIPIC-enabled mail voting system could be used for private elections, corporate elections, or any elections for which mail based voting is desired.

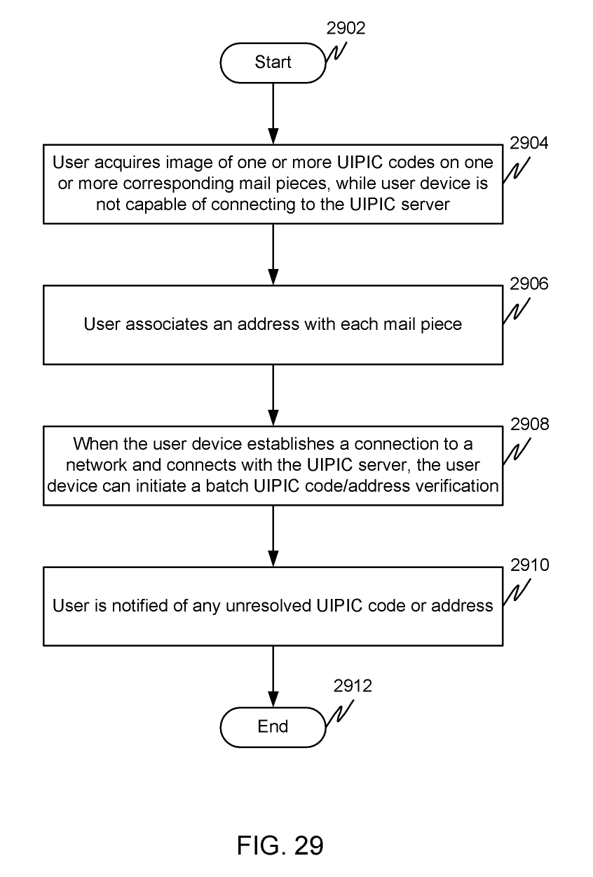

FIG. 29 is a flowchart showing an exemplary method for sending UIPIC-enabled mail when the user device is not able to access a network. Processing begins at step 2902 and continues to step 2904.

In step 2904, the user acquires the image of one or more UIPIC codes on one or more corresponding mail pieces while the user device is not in communication with the UIPIC server. Processing continues to step 2906.

In step 2906, the user associates an address with each UIPIC code. This can also be done as each UIPIC code is input to the user device. Processing continues to step 2908.

In step 2908, once the user device establishes a communications link, it can connect to the UIPIC server and initiate transfer of the UIPIC codes and addresses associated with each. This transfer can be done individually or as a batch. Processing continues to step 2910.

In step 2910, the user is notified of any unresolved UIPIC codes or address and is requested to assist in resolving them. Processing continues to step 2912, where processing ends. It will be appreciated that the above steps can be repeated in whole or in part in order to accomplish an offline UIPIC mailing task.

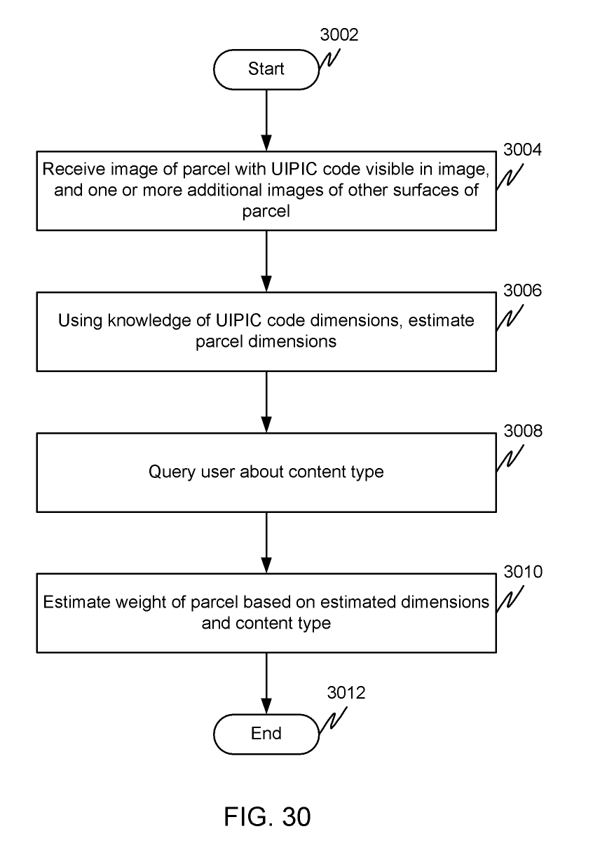

FIG. 30 is a flowchart of an exemplary method for estimating parcel dimensions and weight using a UIPIC-enabled handheld device. Processing begins at step 3002 and continues to step 3004.

In step 3004, the user device acquires an image of a surface of the parcel with a UIPIC barcode visible in the image. The user can also acquire one or more other images of different sides of the parcel. Processing continues to step 3006.

In step 3006, the user device estimates the dimensions of the parcel using predetermined information about the dimensions of the UIPIC barcode. In other words, if the UIPIC barcode dimensions are standardized, then the image of the UIPIC barcode can serve as a sort of “ruler” to establish the dimensions of other objects in the image such as the parcel. Although the UIPIC code will not likely appear on all sides of the parcel, the user device may be able to make a reasonably accurate estimate based on the initial image showing the UIPIC barcode. Processing continues to step 3008.

In step 3008, the user device can query the user about the type of contents of the parcel (e.g., clothes, books, food, liquid, etc.). Processing continues to step 3010.

In step 3010, the UIPIC application program can estimate the weight of the parcel based on the early estimated dimensions and the type of contents. The dimension and weight estimates can be used to determine an estimated delivery cost and estimated delivery time.

The UIPIC application program can query multiple parcel delivery services and provide the user with an estimate of cost and/or delivery time from each service, making it possible for the user to select the delivery service based on cost and/or time. The UIPIC application program can also use the user device location information to provide the user with a list of the closest delivery service drop off locations, thus making it possible for the user to take into account location when selecting a delivery service.

Processing continues to step 3012, where processing ends. It will be appreciated that steps 3002-3012 may be repeated in whole or in part in order to accomplish a contemplated dimension/weight estimation task.

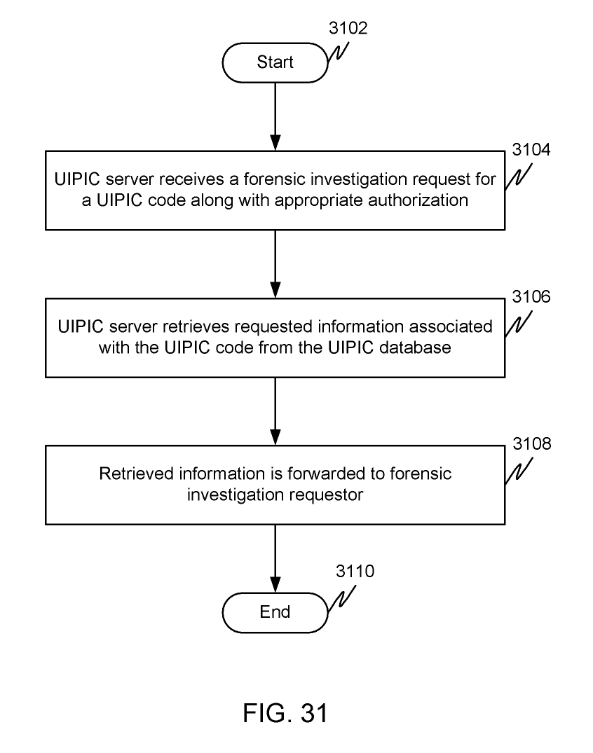

FIG. 31 is a flowchart showing an exemplary embodiment of a method for providing forensic (or audit) mailing information from a UIPIC system. Processing begins at step 3102 and continues to step 3104.

In step 3104, a UIPIC server receives a request for a forensic investigation on a particular UIPIC code or group of codes along with appropriate authorization for such as request. Processing continues to step 3106.

In step 3106, the UIPIC server retrieves the requested information from the UIPIC database and forwards it to the requestor (3108). The information provided can include all available information associated with a UIPIC code or a portion thereof. Processing continues to step 3110 where processing ends. Steps 3102-3110 may be repeated in whole or in part in order to respond to forensic (or audit) requests

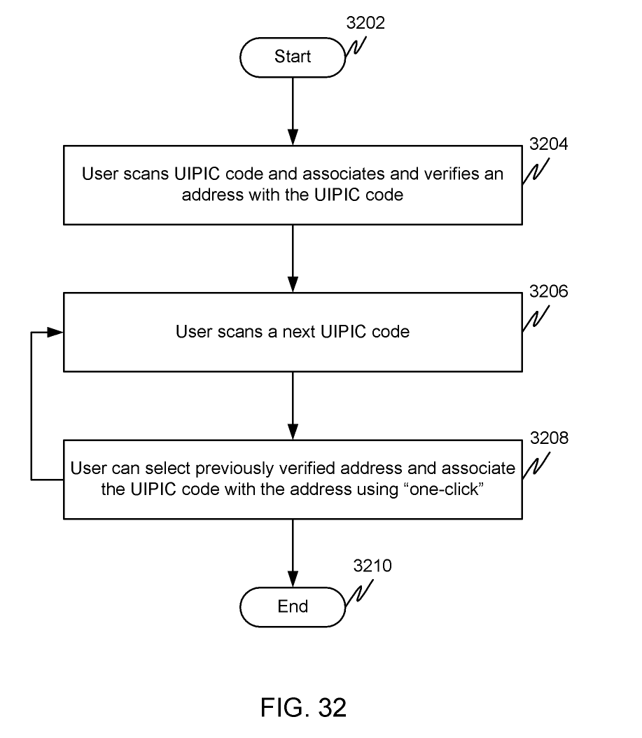

FIG. 32 is a flowchart showing an exemplary method for “one-click” mailing using a UIPIC system. Processing begins at step 3202 and continues to step 3204.

In step 3204, the user scans a UIPIC barcode with the user device and associates and verifies an address (as described above). Processing continues with step 3206.

In step 3206, the user scans a next UIPIC code. Processing continues to step 3208.

In step 3208, the user can select the previously associated and verified address using “one-click” of the user device pointer or button. Depending on the number of parcels, steps 3206 and 3208 can be repeated. Processing continues to step 3210, where processing ends.

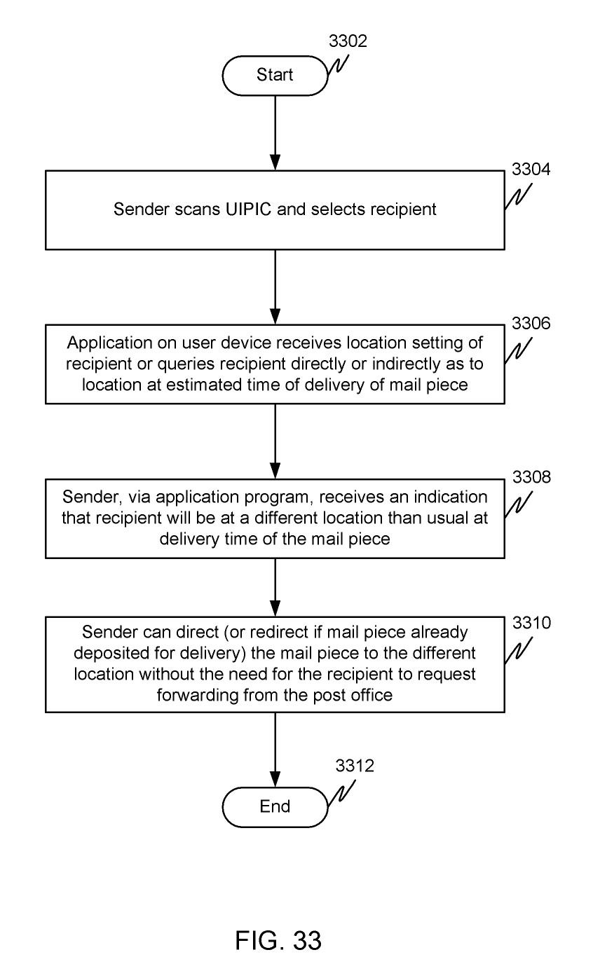

FIG. 33 is flowchart of an exemplary method for redirecting or forwarding mail without requesting forwarding service from the post office. Processing begins at step 3302 and continues to step 3304.

In step 3304, the sender scans the UIPIC and selects a recipient. Processing continues to step 3306.

In step 3306, the application program on the user device receives a location setting from the recipient indicating recipient address at estimated delivery time. Alternatively, the user device could query the user device of the recipient to determine the address at the estimated time of delivery. Processing continues to step 3308.

In step 3308, the sender, via the UIPIC application program, receives an indication that the recipient will be at a different location than usual at time of delivery. Processing continues to step 3310.

In step 3310, the sender can choose whether to send the mail piece to the different location or the usual recipient address location. It should be noted that the sender and recipient can share information about locations and have mail forwarded to alternate location without requesting a forwarding service from the post office.

In another alternative, the recipient could receive an email message that a mail piece is en route for delivery to the usual location and could send a message to the sender requesting that the sender redirect the mail piece to a different location. Processing continues to step 3312, where processing ends. It will be appreciate that steps 3302-3312 can be repeated in whole or in part to perform a contemplated private mail forwarding task.

FIG. 34 is a flowchart showing an exemplary method of generating revenue from advertisements displayed on a UIPIC application program executing on a user device. Processing begins at step 3402 and continues to step 3404.

In step 3404, a targeted (or untargeted) advertisement is displayed on a UIPIC user application screen (see, e.g., FIG. 13). The targeting could be based on information gathered by the UIPIC system including mail recipient locations (e.g., for targeted travel ads), user location (for location-based local advertisements), or any other information gleaned from the user's interaction with the UIPIC device. The UIPIC information could be stored on the user device in a manner similar to browser “cookies” and could be provided to an advertisement display program when the UIPIC application program starts up. Processing continues to step 3406.

In step 3406, the provider or operator of the UIPIC system receives revenue in the form of a commission. The commission can come directly from an advertiser or through a pay-per-click revenue sharing arrangement. The pay-per-click revenue could be generated when a UIPIC user selects the advertisement or purchases goods or services based on the advertisement. Processing continues to step 3408 where processing ends.

It will be appreciated that steps 3402-3408 can be repeated in whole or in part in order to accomplish a contemplated UIPIC advertising program.

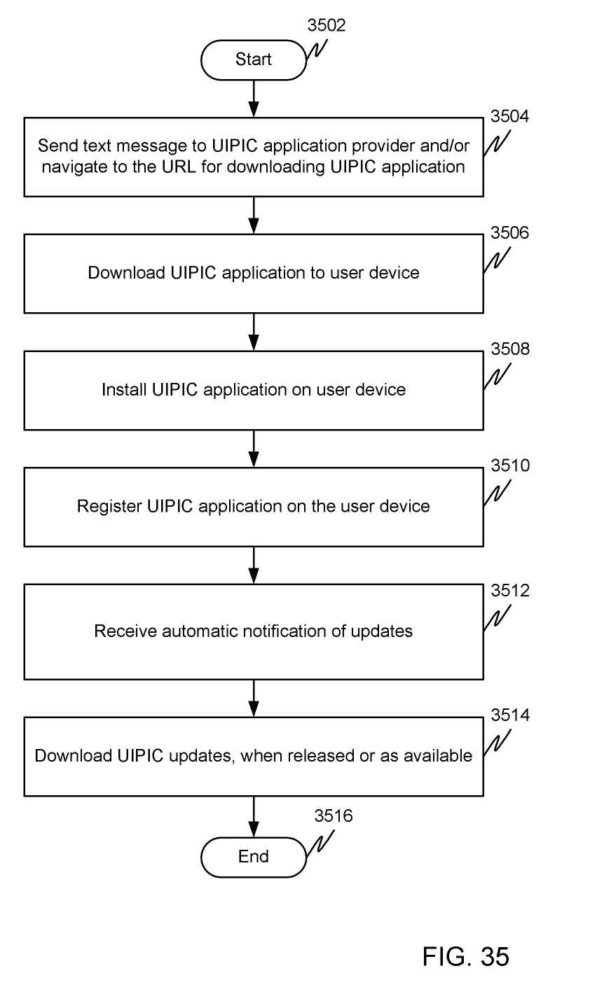

FIG. 35 is a flowchart of an exemplary method for downloading and installing a UIPIC application program in a user device. Processing begins at step 3502 and continues to step 3504.

In step 3504, the user sends a message (e.g., email or text message) to a UIPIC application provider and/or navigates to the UIPIC application provider URL and requests to download the UIPIC application program for his device. Processing continues to step 3506.

In step 3506, the UIPIC application program is downloaded to the user device. Processing continues to step 3508.

In step 3508, the user installs the UIPIC application program on the user device. Processing continues to step 3510.

In step 3510, the user optionally registers the UIPIC application program with the UIPIC server. This can include providing name and address information, email address, phone number, credit card information, or a combination of the above. Processing continues to step 3512.

In optional step 3512, the user receives notification of updates to the UIPIC application program. Processing continues to step 3514.

In optional step 3514, the user downloads and installs a UIPIC application update when released or available. Processing continues to step 3516, where processing ends. It will be appreciated that steps 3502-3516 may be repeated in whole or in part in order to accomplish a contemplated UIPIC application download/install/register/update task.

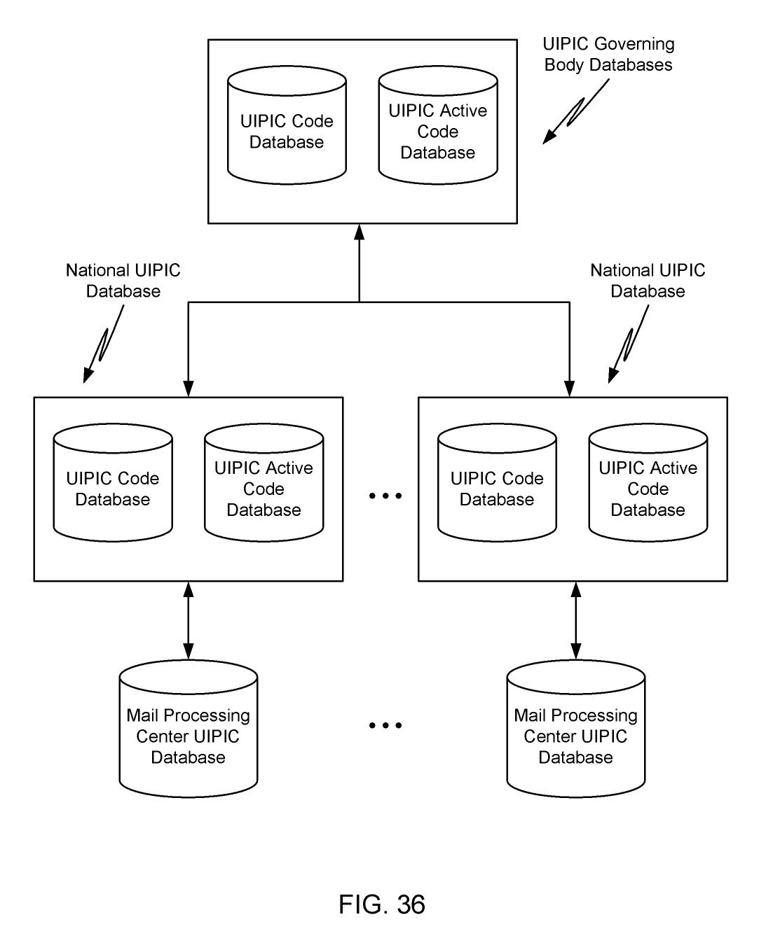

FIG. 36 is a block diagram of an exemplary UIPIC database hierarchy. At a top level, UIPIC governing body databases are shown. At a next level, national UIPIC databases are shown. At a third level, mail processing center UIPIC databases are shown. At each level, the UIPIC database can contain only the information that will be required for their operation. For example, a national UIPIC database may only need records for those UIPIC codes that have been assigned to the country (at least as an initial dataset). The mail processing UIPIC databases may only need to contain the UIPIC records for the mail pieces being processed or which are expected to arrive for processing from another center. By keeping the amount of stored UIPIC records to a minimum level (or at least to a reduced level), the latency of UIPIC code lookup operations can be reduced.

The UIPIC governing body (or clearinghouse) can establish registered partners (e.g., postal authorities, envelope makers, label makers, web sites, etc.) to which blocks of UIPIC codes can be allocated. The clearinghouse is responsible for ensuring that no UIPIC codes are duplicated. Although duplication is not desired, it will be appreciated that some form of duplication may be permitted, for example, if a UIPIC was allocated a number of years ago and has not been used, it may be reallocated and allowed to be used under the assumption that the old code will not be used.

If any patterns of UIPIC code abuse are detected in the system, the clearinghouse can contact the authorized partner to resolve the issue. Any UIPIC code that has not been assigned to a partner may not be able to be used in the system. Abnormal usage patterns can be detected and investigated or the user account suspended. For example, if a user is requesting abnormally high rates of address verification and disproportionately low rates of mail pieces entering the mail stream, the account may be suspended. The UIPIC server database can maintain a history of all transactions and mailing details associated with a UIPIC code.

A UIPIC system can offer customers a variety of payment options as mentioned above. Payment options can also include placing the postage charges on a customer phone bill or other utility bill.

By providing a system in which address databases (or a combined extract database) from different nations can be accessed and used for address verification, the UIPIC system can make it possible for a finest depth of sort encoding regardless of language or national boundary.

The decoding of the UIPIC code can occur in the user device, or the image may be transmitted to the UIPIC server for decoding.

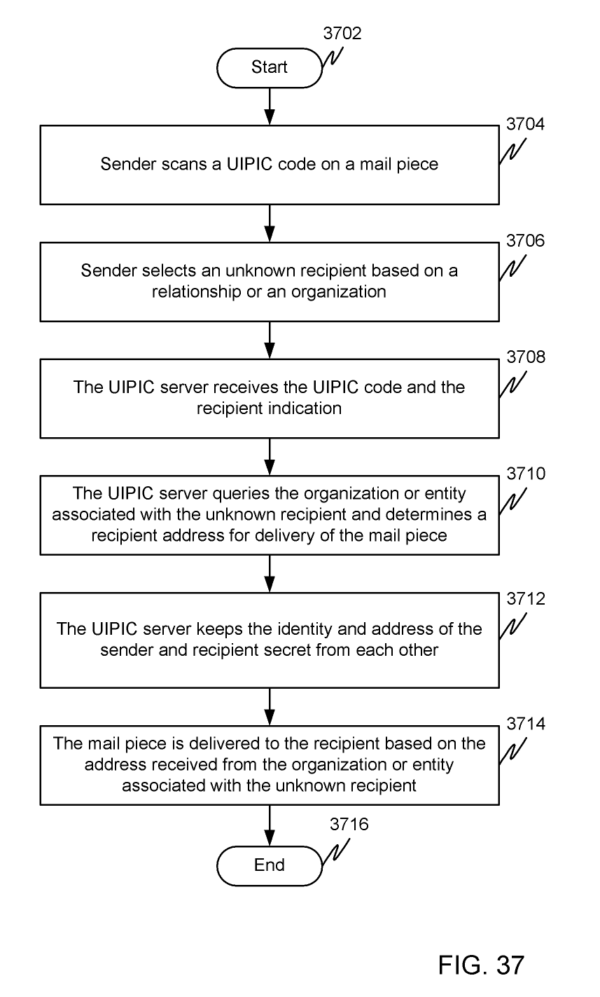

FIG. 37 is flowchart showing an exemplary method for one-way or two-way anonymous mailing. The anonymous mailing embodiment may have applications in situations where parties may need or desire to communicate but for reasons of safety, privacy, etc. wish to remain anonymous. For example, anonymous mailing could be used to facilitate contact between the following: donor and recipient; child and biological parent; criminal and victim; family members under protective order by a court; people in protective custody and friends or family, or the like.

Processing begins at step 3702 and continues to step 3704. At step 3704, a sender scans the UIPIC code on a mail piece. Then, the sender selects an unknown recipient based on a relationship or organization (3706). The sender transmits the UIPIC code and recipient to the UIPIC server.

In step 3708 the UIPIC server receives the UIPIC code and the recipient information. In step 3710, the UIPIC server queries the organization or entity associated with the recipient and determines a recipient address for delivery of the mail piece (of course, the recipient address can be maintained confidentially by the UIPIC server and not be made available to the sender step 3712). Processing continues to step 3714.

In step 3714, the mail piece is delivered to the recipient based on the address in the UIPIC system. Optionally, the sender can remain anonymous as well and the same UIPIC code can be used to return a mail piece to the sender without the recipient knowing the address of the sender (i.e., two-way anonymous mailing). Processing continues to step 3716, where processing ends. It will be appreciated that steps 3702-3716 can be repeated in whole or in part in order to accomplish an anonymous mailing task.

Another embodiment of the invention could be used for entertainment purposes such as letters to Santa or other letters in which one may wish for the letter to receive a certain kind of reply or for which redirection may be desired. For example, the UIPIC system could be used to redirect the letter to Santa to a parent's office or other address so that the parent can learn what a child wants for Christmas. Also, in sending a UIPIC-enabled entertainment mail piece, the sender does need to put actual or real delivery information. For example, having only “Santa, North Pole” written in the child's handwriting on the mail piece would not affect the delivery of the mail using the UIPIC-system.

In another example, the UIPIC system could be used to establish an entertainment mail service in which a child (or any person) can send a letter to a desired figure (real or fictional) and receive a reply. Once the UIPIC enabled mail piece was processed, a message can be sent to the entertainment service identifying the sender and sender's address and a reply letter can be immediately mailed. The entertainment service can include some advance set up information or registration so that the return mail can be personalized (for example, the return letter can be directed to “Suzie” from one of her favorite cartoon characters or other entertainment figure). It will be appreciated that the UIPIC system provide many features that can be used for purposes beyond traditional mail processing such as entertainment, marketing, research, or the like.

The machine readable UIPIC code on a mail piece can be a one-dimensional barcode, a two-dimensional barcode, or the like. An example of a barcode and mobile device software system that is usable on a wireless device is the BeeTagg multicode system provided by connvision AG of Switzerland. In another example, the UIPIC code can be an image which has been encoded with the universal postal code and is readable by a wireless device. Or, the UIPIC code may be associated with a unique image that can be captured by a camera in a user device and application software (either local or remote) can determine the UIPIC code from the image (e.g., kooaba technology available from kooaba AG of Switzerland). In general, a UIPIC barcode can comprise any now known or later developed optical machine-readable representation of data. As an alternative or in addition to a barcode, the UIPIC code can comprise a remote non-optical identification device such as a radio frequency identification (RFID) tag, smart card, implanted microchip, or the like. The UIPIC barcode (or other identification device) can include an optional human readable portion. For example, the unique identification number (or a portion thereof) associated with the UIPIC barcode can be printed along with a machine-readable portion so that a user without access to an imaging or sensing device can use the UIPIC code manually by reading the human-readable portion printed adjacent to the barcode or other machine-readable element and entering the numbers, letters or symbols of the human readable portion into the user device using any input method (e.g., keyboard, touch screen, voice input, or the like).

While various types of identification barcodes or other types of identification systems can be used, it should be appreciated that a key consideration in adopting any particular identification scheme for use with a UIPIC system is the amount of possible unique codes that can be represented. Because the UIPIC system is language-independent it can, in theory, be used in every nation. Therefore, the number of UIPIC codes in use and available for future use would preferably need to be an amount sufficient enough to accommodate the mailing requirements of all subscribing nations (and possibly potential future subscribing nations) or services for a given amount of time into the future. Of course, the length of the amount of time that may need to be accommodated would probably be based on a number of factors (such as percentage of population adopting the UIPIC system, population figures, number of subscribers, average number of mail pieces sent person per year in subscribing areas, etc.), estimates for future factors of use, and a particular implementation being contemplated.

The UIPIC system can make it possible for a mail processing entity (e.g., the USPS, or other public or private mail processor) to reduce operating costs by effectively converting a portion of what would have been hand-written mail into mail that is more readily machine readable (e.g., barcoded mail) and which can be more quickly supplied to a DBCS for sortation. The UIPIC system may also make it possible to reduce the count of un-resolvable address mail and erroneous OCR assignments.

The UIPIC system can make envelope re-use easier by providing a UIPIC code on the mail that can be re-associated with different addresses. Also, the UIPIC system can make it possible to increase the sales of add-on services such as delivery confirmation because the UIPIC system eliminates the need for the mailer to go to the post office to buy such add-on services. Further, the UIPIC system makes it possible for a user to request tracking and delivery confirmation (or other add-on services) at any time, even after the mail piece has been sent or delivered. For example, a tracking service can be offered that includes a fine level of detail for reporting the location of a mail piece. Location data (e.g., latitude-longitude information) can be reported by each mail processing machine that handles a UIPIC enabled mail piece to the UIPIC server and stored in a database record associated with the UIPIC code. The location reporting can also be performed by other mail handling or processing equipment such as trucks, or other delivery vehicles. By making location records available for each step in the mail handling process, it is possible to produce a tracking report having a fine level of detail. Route information for a UIPIC-enabled mail piece can include enough detail to possibly show mail movement between mail processing equipment within a single processing center. The tracking report may be provided to a sender or user for a fee. The report can include actual route information for the UIPIC-enabled mail piece that is provided on a real-time basis and which can be integrated with a graphical display service such as Google Earth, Google Maps, MapQuest, other mapping services, or the like. The mapping service may be selected based on a user device. For example, a mapping service may be selected that can provide graphical location information about the UIPIC-enabled mail piece to a handheld device such as a cellphone or PDA. In addition to being offered as an add-on service to a user of the UIPIC system, the mail piece tracking data can be used to evaluate the performance of the mail handling system as a whole or at a sub-section level.

The UIPIC system provides support for Postal Address Redirection processing and may make it possible to more cheaply redirect mail because a need for a redirection label is reduced or eliminated.

Because UIPIC-enabled mail pieces do not require postage to be applied for mailing, the UIPIC system makes it possible to avoid inconveniences associated with postal rate changes, such as insufficient postage. The UIPIC system can also reduce or eliminate excess postage being applied to a mail piece. The UIPIC system can make it possible for organizations to eliminate the mail metering systems currently in use because, as mentioned above, UIPIC mail does not require postage to be applied.

Once a UIPIC code has been marked as not in use (e.g., after delivery) the UIPIC code can be re-used by simply scanning it and associating a new recipient with the UIPIC code.

The UIPIC user interface could also make it possible for a user to request pick up of parcels or mail pieces (e.g., through a user interface element that indicates a pick up is requested). The user could schedule the pick up or be informed of the pick up time if needed.

The UIPIC barcode can be printed using visible or invisible ink. Also, the UIPIC barcodes can be incorporated as part of a decorative design or other graphic so that they appear pleasing to the eye.

The UIPIC client software (user application) can request a new UIPIC barcode and print it to a wired or wirelessly connected printer. The UIPIC client software can be configured into any language suitable for use on the device. Language choice can be a parameter used when communicating between the UIPIC client software and the UIPIC server for address verification.

A user can request address redirection while a UIPIC mail piece is still in the delivery process. The post office can charge a fee for user-initiated address redirection and sell it as an add-on service.

Senders and recipients can request (perhaps for a small fee) notification of mail pieces entering the mail stream for delivery to them and of mail pieces that have been delivered.

The delivery notification message for a UIPIC mail piece may also be sent to a third party to provide proof of delivery. For example, a court, arbitrator, or other such body may be able to use UIPIC delivery confirmation as a new form of service of process or at least as an acceptable form of proof that an order or procedure was complied with. The delivery confirmation could be monitored by another organization, such as a child support enforcement agency to monitor payments of child support (or at least the appearance of payments being made directly to a parent).

Another feature of UIPIC system is that the collected detailed mailing and delivery information can make it possible for the post office to provide a more accurate estimate of delivery time for a mail piece.

The UIPIC system can link a UIPIC code and an address or delivery point as described above. Also, the UIPIC system can link a UIPIC code to a specific person, for example in those countries where a housing database (or database of all people receiving mail) is provided the UIPIC code may be associated with the address and an individual at that address.

Because recipient (and possibly sender) information is not necessarily visible on a UIPIC-enabled mail piece, the UIPIC system can make it possible to reduce identity-theft.

An embodiment can include a feature for pairing a media message (or media clip) with the UIPIC code and mail piece. The media message can be stored and delivered by the UIPIC server. The media message can include a video clip, an audio clip, an image, a text message, or the like. For example, a user or sender sending a birthday present can add a video clip of himself singing “Happy Birthday” to the recipient. Once the recipient scans the UIPIC code, the recipient will be presented with the birthday song video clip.

For storing the media clip, the sender could select from a variety options, including having the UIPIC server store the media message in its database and deliver electronically to the recipient, or the UIPIC server could instruct a mail processing center or equipment to place the media message onto a media form such as CD, DVD, flash memory device, etc. and deliver the media message along with the mail piece. Preparation of the media message onto a media for delivery can occur at the last mail processing center prior to delivery or can occur at any other suitable mail processing center (e.g., certain mail processing center may be specially equipped to handle media message requests). In general, any now known or later developed method or apparatus for storing and delivering media content may be used.

A recipient can be informed about the availability of the media message in a variety of ways. For example, the UIPIC system can instruct a mail processing machine to apply a message to the mail piece such as “UIPIC™ Media Clip Available. For viewing, please scan barcode or log on to UIPIC.org,” or other similar message that will alert the recipient to the availability of a media message and may, optionally, provide instructions for accessing the message. Alternatively, the UIPIC system can instruct the mail processing equipment to apply a label to the mail piece indicating availability of media message. In another alternative, a mail carrier can receive an indication of mail pieces having an associated media clip and can include an instructional card or flyer for giving the recipient instructions on how to retrieve and view/listen to the media clip.

A recipient can view the media clip on the user device (e.g. mobile device), via a display device that can read the media (e.g., CD, DVD, flash memory device, etc.) such as a computer, set top box, image or video player, media player, or other suitable display device. The recipient can access the media clip by scanning the UIPIC code on the mail piece. The application software on the user device can then access the UIPIC server and retrieve the media clip and play it on the user device. Alternatively, the recipient can log onto the UIPIC service via the internet and enter account information and/or the UIPIC code to retrieve the media clip.

The media messages or clips may be retained by the UIPIC server for a predetermined period of time (e.g., three months). Also, the media clips may be able to be transferred to a video or media hosting website such as YouTube, Flickr, etc. by the recipient or the sender.

In another alternative embodiment, the media message is hosted on another service such as YouTube or Flickr and a link to the media on that server is included in the UIPIC mail piece record such that the UIPIC server merely stores the link information to access the media on another server when the recipient scans the UIPIC code or logs on to view the media message.

The associated media message embodiment can also be used for encrypted communications. For example, a sender can send a UIPIC enabled mail piece and associate a media clip with the mail piece. The mail piece may contain a portion of a secret message or encryption key and the media clip may contain another portion of the secret message or key. The recipient can retrieve a portion of the secret message from the mail piece itself and then access the media clip to retrieve the other portion. Individually each portion may not contain any useful information, but when put together, the two piece of information may form a complete communication such as a message or an encryption key to decrypt some other data. The media clip may be stored and treated in a special way by the UIPIC server (e.g., stored as an encrypted file for access only by the recipient using a predetermined user device).

An embodiment can include a feature for utilizing the UIPIC server as a proxy server or application server in such a way that a sender can add a reference to an application or web page to the composite data associated with the UIPIC mail piece. This can make it possible for a recipient to scan the UIPIC code and be presented or directed to the sender's application or web page. The sender can customize or tailor the presentation of an application or web page to the specific recipient. For example, the sender could associate the UIPIC code with a web page having the sender's account; tailored to the sender's preferences or habits, or in some other way customized or tailored based on a characteristic of the recipient.

An example of application or proxy server feature is mail voting. The voting authority can instruct the UIPIC server to present the voting software application to the recipient when the recipient scans the UIPIC code associated with the ballot. The recipient can then vote online using the voting software application and the user device and also return the paper ballot card via mail. This can make it possible for the voting authority to immediately tally the electronic votes while still receiving a paper copy of the ballot in the mail for record keeping and fraud detection.

Any of the embodiments described above can also include a feature where an advertiser pre-associates a UIPIC code on a response mail piece to a specific customer or prospective customer. Then, when the customer or prospective customer scans the UIPIC code on the response mail piece or advertisement, the UIPIC application (or UIPIC server) can optionally direct the user to a web page or application, the advertiser can also optionally receive a notification indicating that the UIPIC code associated with the customer or prospective customer has been scanned. Alternatively, the advertiser may receive notification of the scanning of the mail piece when it is first scanned by the postal service during sorting or delivery processing. The web page, or application presented to the customer or prospective customer can be custom tailored to the specific customer or prospect based on the knowledge of the identity, preferences or other data associated with the customer or prospective customer. The identity, preference, or other information can be determined in one of several ways, including for example: by having the UIPIC code associated with the customer; by having a generic (i.e., customer independent) UIPIC code, but using information from the user device or UIPIC application to identify the customer and provide identity, preference data, or the like; by providing a generic UIPIC code and identifying the customer from data stored in the user device or on the UIPIC server (e.g., “cookies”, or other customer tracking data).

In another embodiment, the UIPIC application can be adapted to permit the user to send an address to the UIPIC server for verification/validation and then return a UIPIC code for the user to write or otherwise apply to the mail piece. In other words, the mail piece could be UIPIC enabled but with only a human readable UIPIC code applied to the mail piece (e.g., the one that the user wrote on the mail piece). The address could be sent via one of several methods including: sending a contact address, the user entering an address manually, taking an image of an address, or the like. The same address verification and address book updating functions, as described above, could be performed. This embodiment can make it possible for a person to use the UIPIC system without having a UIPIC barcode on the mail piece. The UIPIC number written on the mail piece could be read by mail processing equipment and determined to be a UIPIC code (e.g., by starting with a predetermined alphanumeric sequence). This embodiment would also make it possible for a user without a camera enabled device to send UIPIC enabled mail.

An embodiment could also include an address completion feature. In particular, the UIPIC application program could send whatever address data the user has available, even if incomplete (e.g., missing the ZIP code), to the UIPIC server for address verification/validation. The UIPIC server could attempt to resolve the address and present the user with the results of the address resolution process. The user can select a resolved address to use as the recipient address for the mail piece. Optionally, the user's address book or contact list in the device could be updated with any additional information provided by the UIPIC system.

In another embodiment, the user could take a picture of the address on a mail piece and send it to the UIPIC server for address verification/validation. The UIPIC server could attempt to automatically read the address and verify/validate the address. If successful, the UIPIC server could return the address to the user device for optional entry to the user's address book or contact list. Even if the address has not been determined or resolved, it may be possible to assign a UIPIC code number to the address and then to process the address for recognition, even prior to the mail piece being deposited for delivery into the mail stream. In other words, this embodiment can make it possible for the address on a mail piece to be subjected to an automatic or manual recognition process before the mail piece has been handled by a mail sorting machine. With the address recognition process being based on the image of the mail piece sent by the user via the UIPIC system.

An embodiment can also be adapted to include a function for uploading addresses in advance to the UIPIC server and associating the addresses with the user's account. These addresses may be stored confidentially by the UIPIC server. By having pre-loaded the address information, the UIPIC system can pre-verify the addresses, convert addresses to standard postal format if needed and have them ready for the user to select from at mailing time. This feature may make it possible for a user to upload address from different applications, for example, addresses from a business or work contact list, addresses from a personal contact list, and addresses from a variety of sources so that the addresses can be presented in one list by the UIPIC application on the user device. This feature can make it possible to eliminate the need for a user to have to open another application or list during the process of sending a UIPIC enabled mail piece. In other words, by having the addresses preloaded in the UIPIC system (and, possibly pre-verified) a user can send UIPIC enabled mail using only the UIPIC application. This feature may also facilitate the “one-click” mailing method described above.

It should be appreciated that any operations described above may be repeated in whole or in part in order to perform a contemplated UIPIC addressing, sorting and/or delivery task. Further, it should be appreciated that the operations mentioned above may be performed on a single or distributed processor. Also, unless specifically described otherwise, the processes, modules, and units described in the various figures of the embodiments above may be distributed across multiple computers or systems or may be co-located in a single processor or system.

Embodiments of the method, system and computer program product (i.e., software stored on a computer readable medium) for UIPIC addressing, sorting and/or delivery, may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein can be used to implement embodiments of the method, system, or computer program product for UIPIC addressing, sorting and/or delivery.

Furthermore, embodiments of the disclosed method, system, and computer program product for UIPIC addressing, sorting and/or delivery may be readily implemented, fully or partially, in software using, for example, object or object-oriented software development environments that provide portable source code that can be used on a variety of computer platforms. Alternatively, embodiments of the disclosed method, system, and computer program product for UIPIC addressing, sorting and/or delivery can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, and computer program product UIPIC addressing, sorting and/or delivery can be implemented in hardware and/or software using any known or later developed systems or structures, devices and/or software by those of ordinary skill in the applicable art from the functional description provided herein and with a general basic knowledge of the computer and/or mail processing, sorting and delivery arts.

Moreover, embodiments of the disclosed method, system, and computer program product for UIPIC addressing, sorting and/or delivery can be implemented in software executed on a programmed general-purpose computer, a special purpose computer, a microprocessor, or the like. Also, the UIPIC addressing, sorting and/or delivery systems and methods can be implemented as a program embedded on a personal computer such as a JAVA® or CGI script, as a resource residing on a server or graphics workstation, as a routine embedded in a dedicated processing system, or the like. The methods and systems can also be implemented by physically incorporating the methods for UIPIC addressing, sorting and/or delivery into a software and/or hardware system, for example a handheld wireless device or a mail sorting machine.

It is, therefore, apparent that there is provided in accordance with the present invention, a method, system, and computer program product for UIPIC addressing, sorting and/or delivery. While this invention has been described in conjunction with a number of embodiments, it is evident that many alternatives, modifications and variations would be or are apparent to those of ordinary skill in the applicable arts. Accordingly, applicant intends to embrace all such alternatives, modifications, equivalents and variations that are within the spirit and scope of this invention.

What is claimed is:

1. A computer readable medium having software instructions stored thereon for registering a universal postal code affixed to a mail piece, the software instructions, when executed by a processor disposed within a wireless device, cause the processor to perform operations comprising:
acquiring an image of the universal postal code from an image sensor operatively coupled to the wireless device;
automatically recognizing and decoding the universal postal code image to obtain a universal postal code that is unique with respect to the mail piece such that the mail piece can be identified and differentiated from other mail pieces using only the universal postal code affixed to the mail piece;
verifying the universal postal code by communicating with a universal postal code server computer;
obtaining, from the wireless device, a recipient address to which delivery of the mail piece will be attempted;
determining if the recipient address is valid by communicating the recipient address to the universal postal code server computer and receiving an indication of address validity from the universal postal code server computer;
associating, in the wireless device, the universal postal code with the recipient address, when the address is determined to be valid; and
transmitting, from the wireless device, the universal postal code data and the associated recipient address to the universal postal code server computer for registration in an active universal postal code database, such that the mail piece can be sorted for delivery based only on the universal postal code affixed to the mail piece.

2. The machine readable medium of claim 1, wherein the acquiring includes capturing an image of a machine readable indicia corresponding to the universal postal code.

3. The machine readable medium of claim 1, wherein when the universal postal code has been released for use prior to the verifying, the verifying includes determining if the universal postal code is available for use.

4. The machine readable medium of claim 1, wherein the universal postal code is not released for use prior to the verifying, and at verification time, a new universal postal code is released and associated with the acquired universal postal code data.

5. The machine readable medium of claim 1, wherein the operations further comprise displaying a user interface on a display device coupled to the processor, the user interface including a status element to indicate a status associated with the acquiring, a list element showing one or more recipients, and a control element to associate the acquired universal postal code data with a recipient selected form the list element.

6. The machine readable medium of claim 1, wherein the user interface is also adapted to display an advertisement.

7. The machine readable medium of claim 1, wherein the operations further comprise:
receiving delivery confirmation information from the universal postal code server indicate a status of delivery when the mail piece bearing the universal postal code has been delivered or when delivery of the mail piece has been attempted and refused by the recipient;
storing the delivery confirmation information locally in a memory coupled to the processor; and
updating a user interface element associated with the universal postal code to indicate the received delivery confirmation information.

8. The machine readable medium of claim 1, wherein the recipient address is obtained from a social networking service.

9. The machine readable medium of claim 1, wherein the recipient address is obtained during a transaction in which the recipient is a buyer.

10. The machine readable medium of claim 1, wherein the acquiring, verifying, obtaining, determining, associating and transmitting are performed by a merchant and the recipient address is an address used by the merchant for receiving returned goods and the mail piece is a merchandise return shipping label.

11. The machine readable medium of claim 1, wherein at the time of acquiring, obtaining and associating, if the processor is not in communication with the universal postal code server computer and the verifying, determining and transmitting are deferred until the device establishes communications with the universal postal code server computer.

12. The machine readable medium of claim 11, wherein, after the deferred verifying, determining and transmitting are performed, a notification of any unresolved universal postal code or address is provided.

13. The machine readable medium of claim 1, wherein the operations further comprise receiving dimension information and weight information about the mail piece and associating the dimension and weight information with the universal postal code.

14. The machine readable medium of claim 1, wherein the dimension information is determined from one or more images of the mail piece by using a portion of one of the images having the machine readable portion and using predetermined dimensions of the machine readable portions to estimate the dimension information.

15. The machine readable medium of claim 14, wherein the weight information is determined based on the dimension information and content type of the mail piece

16. The machine readable medium of claim 1, wherein the operations further comprise:
acquiring another universal postal code data associated with another unique universal postal code affixed to a different mail piece;
verifying the other universal postal code by communicating with the universal postal code server computer; and
associating the other universal postal code with the recipient address associated with the universal postal code using a one-click user interface element.

17. The machine readable medium of claim 1, wherein the operations further comprise:
receiving an indication of recipient location at estimated time of delivery of the mail piece;
displaying an indication that recipient will be at an address different from the recipient address at the estimated time of delivery of the mail piece; and
transmitting a request to deliver the mail piece to the different address when the user selects to have the mail piece delivered to the different address.

18. The machine readable medium of claim 1, wherein the software is configured to be downloaded to a wireless device and the processor, display and memory are disposed in the wireless device.

19. A universal postal code server computer comprising:
a processor; and
a memory having stored therein software instructions for programming the processor to perform operations including:
receiving a universal postal code registration message from a mailer device, the universal postal code registration message including universal postal code data and recipient address information;
determining, based on the universal postal code data, whether a new universal postal code needs to be released or whether a previously released universal postal code is being used;
releasing a universal postal code when the determining indicates that a new universal postal code needs to be released;
verifying a previously released universal postal code when the determining indicates that a previously released universal postal code is being used;
verifying the recipient address information including conforming the address information to a standard address format when the recipient address information is not in the standard format; and
adding the universal postal code and the recipient address information to an active universal postal code database.

20. The universal postal code server computer of claim 19, wherein the universal postal code registration message further includes an indication of one or more delivery service options selected by a mailer.

21. The universal postal code server computer of claim 19, wherein the operations further include:
receiving a recipient information request from a mail processing system, the recipient information request including a universal postal code read from a mail piece being processed;
looking up the universal postal code in the active universal postal code database;
if the universal postal code is found in the active universal postal code database, sending a response message to the mail processing system indicating a recipient address associated with the universal postal code read from the mail piece and any selected delivery service options;
if the universal postal code is not found in the active universal postal code database, returning a message to the mail processing system that the universal postal code was not found, and, when an identity of the mailer can be determined from the universal postal code, indicating to the mail processing system that an attempt is being made to contact the mail piece mailer to obtain recipient address information;
contacting the mail piece mailer, when known from the universal postal code read from the mail piece, and requesting recipient address information for the mail piece; and
when recipient address information is received from the mail piece mailer, forwarding received recipient address information to the mail processing system.

22. The universal postal code server computer of claim 19, wherein the operations further include:
receiving a mail piece delivery message from a mail carrier device indicating delivery status of a mail piece being delivered, the mail piece delivery message including a universal postal code associated with the mail piece being delivered;
looking up the universal postal code in the active universal postal code database and retrieving a database record associated with the universal postal code of the mail piece being delivered;
updating the database record with delivery status information received from the mail carrier device; and
sending a delivery confirmation message to a mailer of the mail piece being delivered to indicate delivery status.

23. The universal postal code server computer of claim 22, wherein the operations further include:
requesting a delivery location from the mail carrier device when the database record indicates that a delivery location confirmation service has been requested; and
updating the database record with delivery location information received from the mail carrier device.

24. The universal postal code server computer of claim 22, wherein the operations further include:
requesting an image from the mail carrier device when the database record indicates that delivery image service has been requested; and
updating the database record with delivery image information received from the mail carrier device.

25. A mail processing machine comprising:
a mail piece scanner;
a processor coupled to the mail piece scanner; and
a memory coupled to the processor, the memory having stored therein software instructions for programming the processor, the instructions, when executed by the processor cause the processor to perform operations including:
acquiring an image of a mail piece using the mail piece scanner;
automatically recognizing and decoding a universal postal code in the mail piece image to obtain a universal postal code associated with the mail piece;
requesting delivery address information from a universal postal code server by sending an electronic message containing the universal postal code associated with the mail piece;
receiving delivery address information from the universal postal code server; and
sorting the mail piece for delivery according to the received delivery address information such that the mail piece can be delivered to the delivery address without performing an optical character recognition operation on the mail piece image to obtain the delivery address information.

26. The mail processing machine of claim 25, wherein the operations further include storing, in a local database, a database record having the universal postal code and the received delivery address information.

27. The mail processing machine of claim 25, wherein the operations further include forwarding the database record to a mail processing center, the mail processing center being selected based on the delivery address information.

28. The mail processing machine of claim 25, wherein the operations further include providing a human readable delivery address presentation on the mail piece.

29. The mail processing machine of claim 25, wherein the mail processing machine is adapted to process military mail and the universal postal code on the mail piece is associated with a military mail recipient and the delivery address information is for a military mail delivery point.

30. A mail piece addressing and delivery system comprising:
a mail piece having a first universal postal code as a destination universal postal code and a second universal postal code as a sender universal postal code associated with an address of the sender, the mail piece having no human readable address information for either of a sender or a recipient;
a mail processing system adapted to automatically recognize and decode each of the first and second universal postal codes and deliver the mail piece according to a destination address associated with the destination universal postal code if possible;
if delivery of the mail piece is not possible or is refused, the mail processing system being adapted to return the mail piece to the address of the sender.

31. The mail piece delivery system of claim 30, wherein the destination address of the mail piece has been predetermined and is not available to the sender.

32. The mail piece delivery system of claim 30, wherein the sender address is kept private from the recipient of the mail piece such that the recipient is prevented from determining the address of the sender.

33. A mail carrier device comprising:
a processor;
a scanner coupled to the processor, the scanner adapted to scan universal postal codes;
a display device coupled to the processor; and
a memory coupled to the processor, the memory having software instructions stored therein for programming the processor to perform operations when the software instructions are executed, the operations including:
acquiring, using the scanner, an image of a universal postal code on a mail piece being delivered;
decoding the universal postal code image to obtain a universal postal code;
sending a message requesting delivery information for the mail piece, the message including the universal postal code;
displaying the delivery information on the display device; and
sending a message indicating delivery of the mail piece.

34. The mail carrier device of claim 33, wherein the operations further include:
receiving a request to obtain delivery location information;
obtaining delivery location using a geographic position device coupled to the processor; and
transmitting the delivery location to another system.

35. The mail carrier device of claim 33, wherein the operations further include:
receiving a request to obtain delivery image information;
obtaining a delivery image using an imaging device coupled to the processor; and
transmitting the delivery image information to another system.

36. A method for automatically tabulating votes, the method comprising:
providing a block of universal postal codes to an election organization, the block of universal postal codes being associated with a mailing account of the election organization;
associating an address of the election organization with each of the universal postal codes in the block;
associating each universal postal code with a unique registered voter;
mailing ballot cards and one or more universal postal codes on adhesive labels to each voter, the ballot cards having neither a delivery address or postage affixed to them, wherein a voter can vote by affixing one or more universal postal code labels to a ballot card and placing the ballot card in the mail for delivery, the ballot card maintaining voter anonymity by having no human readable voter or ballot choices visible on the ballot card;
receiving the ballot card at a mail processing center and automatically recognizing and decoding the one or more universal postal codes on the ballot card;
securely transmitting electronically the decoded universal postal codes to the election organization such that votes can be tabulated automatically prior to the election organization physically receiving the ballot card; and
delivering the ballot card in accordance with the delivery address information associated with the one or more universal postal codes.

37. The method for automatically tabulating votes of claim 36, wherein each universal postal code in the block is associated with a combination of information including a unique registered voter identification number and a ballot choice.

38. The mail piece addressing and delivery system of claim 30, wherein the first universal postal code and the second universal postal code are selected from a group of universal postal codes, the group of universal postal codes including enough universal postal codes to provide universal postal codes for all mail being processed by a postal authority for a predetermined period of time.
